(19) United States
(12) Patent Application Publication
(10) Pub. No.: US 2025/0113124 A1
(43) Pub. Date: Apr. 3, 2025

(54) SUB-PASSBAND RAMPING AS A METHOD OF MANAGING POWER TRANSIENTS IN C+L BAND OPTICAL LINE NETWORKS

(71) Applicant: Infinera Corp., San Jose, CA (US)

(72) Inventors: Jonathan Michael Buset, San Jose, CA (US); Nisar Ahmed, Bellevue, WA (US); Sanjeev Ramachandran, Manipal, IN (US); Ashok Kunjidhapatham, Karnataka (IN); Thomas Gerard, Campbell, CA (US); Francisco Javier Vaquero Cabaliero, San Jose, CA (US)

(21) Appl. No.: 18/901,545

(22) Filed: Sep. 30, 2024

Related U.S. Application Data
(63) Continuation of application No. 63/541,715, filed on Sep. 29, 2023.

(51) Int. Cl. H04Q 11/00; H04J 14/02

(52) U.S. Cl. CPC H04Q 11/0062; H04J 14/0212; H04Q 2011/0086; H04Q 2213/13332

(57) ABSTRACT

Methods and systems are herein disclosed, including a method comprising receiving an operation to execute, dividing the operation into first and second sub-operations, executing the first sub-operation in a first loading cycle, and executing the second sub-operation in a second loading cycle after the first loading cycle. The operation is either an activation or a deactivation of one or more signal passbands in an optical spectrum for transmission in a fiber optic line. Each of the one or more signal passbands contains one or more optical carriers carrying user data. The first sub-operation identifies one or more first sub-passbands. The second sub-operation identifies one or more second sub-passbands. The one or more first sub-passbands and the one or more second sub-passbands are each a portion of the one or more signal passbands.

### CROSS-REFERENCE TO RELATED APPLICATIONS

This application claims priority to the provisional patent application identified by U.S. Ser. No. 63/541,715, filed Sep. 29, 2023, titled “SUB-PASSBAND RAMPING AS A METHOD OF MANAGING POWER TRANSIENTS IN C+L BAND OPTICAL LINE NETWORKS”, the entire content of which is hereby expressly incorporated herein by reference.

### BACKGROUND ART

Optical networking is a communication means that utilizes signals encoded in light to transmit information, e.g., data, as an optical signal in various types of telecommunications networks. Optical networking may be used in relatively short-range networking applications such as in a local area network (LAN) or in long-range networking applications spanning countries, continents, and oceans. Generally, optical networks utilize optical amplifiers, a light source such as lasers or LEDs, and wavelength division multiplexing to enable high-bandwidth communication.

Optical networks are a critical component of the global Internet backbone. This infrastructure acts as the underlay, providing the plumbing for all other communications to take place (e.g., access, metro, and long-haul). In the traditional 7-layer OSI model, Optical networks constitute the Layer 1 functions, providing digital transmission of bit streams transparently across varying distances over a chosen physical media (in this case, optical). Optical networks also encompass an entire class of devices (which are referred to as Layer 0), which purely deal with optical photonic transmission and wavelength division multiplexing (WDM). This includes amplification, (re-) generation, and optical add/drop multiplexing (OADM). The most widely adopted Layer 1/Layer 0 transport networking technologies today, referred to as Optical Transport Networks (OTN), are based on ITU-T standards. Both these classes of networks are connection-oriented and circuit-switched in nature.

Dense Wavelength Division Multiplexing (DWDM) is an optical transmission technology that uses a single optical fiber link to simultaneously transport multiple optical services of different wavelengths. The different wavelengths are conventionally separated into several frequency bands, each frequency band being used as an independent channel to transport optical services of particular wavelengths. The Conventional Band (C-band) typically includes signals with wavelengths ranging from 1530 nm to 1565 nm, is the frequency band in which optical services experience the lowest amount of loss, and is the band most commonly used in DWDM. The Long-wavelength Band (L-band), which typically includes signals with wavelengths ranging from 1565 nm to 1625 nm, is the frequency band in which optical services experience the second lowest amount of loss, and is the frequency band often used when the C-band is insufficient to meet bandwidth requirements. Optical line systems that use both the C-band and the L-band are referred to as C+L or C/L optical line systems.

In modern optical communication systems, there is a constant drive to increase data transmission rates while reducing the overall cost per bit. This has led to a rapid evolution in optical transponder technology, particularly in terms of symbol rates (baud rate). Previous generation transponders operated at approximately 96 Gigabaud (GBd), utilizing an optical bandwidth of approximately 102 GHz. Current generations have pushed this to approximately 140 GBd, utilizing an optical bandwidth of approximately 160 GHz. Next-generation systems are projected to reach up to 280 GBd, utilizing an optical bandwidth of approximately 320 GHz.

Superchannels have emerged as a key technology in this landscape. A superchannel is defined as a single optical passband containing one or more optical carriers between a source and destination. These carriers are logically grouped and co-routed through the network. In some implementations, digital traffic is distributed across multiple carriers within a superchannel, and gain sharing can be provided.

Most optical line systems manage services at the passband level, also referred to as Service Media Channels. As carrier baud rates increase, the total bandwidth occupied by a single superchannel also expands. For instance, a superchannel comprising 12 carriers at 102 GHz each occupies nearly 1.2 THz of optical spectrum, which is equivalent to one-quarter of the extended C-band.

The trend towards higher baud rates and wider superchannels presents significant challenges in optical network management, particularly in C+L band systems and other ultra-wide band optical systems. These systems are susceptible to large loading changes due to Stimulated Raman Scattering (SRS). When large passbands are loaded or unloaded in a single operation, it can result in substantial power transients in existing channels. These transients may degrade performance and potentially lead to traffic disruptions.

Furthermore, optical line systems employing Amplified Spontaneous Emission (ASE) idlers face additional complexities. These systems typically perform loading operations over multiple loading cycles to create gaps in the ASE spectrum before activating data traffic, or vice versa for deactivation. This multi-cycle process can lead to power transients during the transition phase due to changes in the power spectrum.

As the industry continues to push the boundaries of optical communication technology, addressing these challenges becomes crucial for maintaining network stability and performance while leveraging the benefits of higher baud rates and wider superchannels.

### SUMMARY OF THE INVENTION

In a first implementation, the problems of maintaining network stability and performance while leveraging the benefits of higher baud rates and wider superchannels are solved by a network element, comprising: a processor; and a non-transitory processor-readable medium storing processor-executable instructions that when executed by the processor cause the processor to: receive an operation to execute, the operation being one of an activation and a deactivation of one or more signal passbands (SPs) in an optical spectrum for transmission in a fiber optic line, each of the one or more SPs containing one or more optical carriers carrying user data; divide the operation into a plurality of sub-operations including a first sub-operation and a second sub-operation, the first sub-operation identifying one or more first sub-passbands, the second sub-operation identifying one or more second sub-passbands, each of the one or more first sub-passbands and the one or more second sub-passbands being a portion of the one or more SPs; execute the first sub-operation in a first loading cycle, thereby activating or deactivating the one or more first sub-passbands in the optical spectrum for transmission in the fiber optic line; and execute the second sub-operation in a second loading cycle after the first loading cycle, thereby activating or deactivating the one or more second sub-passbands in the optical spectrum for transmission in the fiber optic line.

In a second implementation, the problems of maintaining network stability and performance while leveraging the benefits of higher baud rates and wider superchannels are solved by a network element, comprising: an amplified spontaneous emission (ASE) source configured to generate ASE noise; a processor; and a non-transitory processor-readable medium storing processor-executable instructions that when executed by the processor cause the processor to: activate an ASE passband (AP) in an unoccupied band of an optical spectrum for transmission in a fiber optic line, the AP having an ASE start frequency and an ASE end frequency and being loaded with the ASE noise; receive an operation to execute, the operation being an activation of one or more signal passbands (SPs) in the optical spectrum for transmission in the fiber optic line, the one or more SPs having a SP start frequency greater than or equal to the ASE start frequency and a SP end frequency less than or equal to the ASE end frequency, each of the one or more SPs containing one or more optical carriers carrying user data; divide the operation into a plurality of sub-operations including a first sub-operation and a second sub-operation, the first sub-operation identifying one or more first sub-passbands and the second sub-operation identifying one or more second sub-passbands, each of the one or more first sub-passbands and the one or more second sub-passbands being a portion of the one or more SPs; deactivate a first portion of the AP in the optical spectrum for transmission in the fiber optic line, the first portion overlapping with the one or more first sub-passbands; execute the first sub-operation in a first loading cycle, thereby activating the one or more first sub-passbands in the optical spectrum for transmission in the fiber optic line; deactivate a second portion of the AP in the optical spectrum for transmission in the fiber optic line, the second portion overlapping with the one or more second sub-passbands; and execute the second sub-operation in a second loading cycle after the first loading cycle, thereby activating the one or more second sub-passbands in the optical spectrum for transmission in the fiber optic line.

In a third implementation, the problems of maintaining network stability and performance while leveraging the benefits of higher baud rates and wider superchannels are solved by a network element, comprising: an amplified spontaneous emission (ASE) source configured to generate ASE noise; a processor; and a non-transitory processor-readable medium storing processor-executable instructions that when executed by the processor cause the processor to: activate one or more signal passbands (SPs) in an optical spectrum for transmission in a fiber optic line, each of the one or more SPs containing one or more optical carriers carrying user data; receive an operation to execute, the operation being a deactivation of at least one of the one or more SPs in the optical spectrum for transmission in the fiber optic line; divide the operation into a plurality of sub-operations including a first sub-operation and a second sub-operation, the first sub-operation identifying one or more first sub-passbands and the second sub-operation identifying one or more second sub-passbands, each of the one or more first sub-passbands and the one or more second sub-passbands being a portion of the at least one of the one or more SPs; execute the first sub-operation in a first loading cycle, thereby deactivating the one or more first sub-passbands in the optical spectrum for transmission in the fiber optic line; activate a first ASE passband (AP) in a first unoccupied band of the optical spectrum for transmission in the fiber optic line previously occupied by the one or more first sub-passbands, the first AP being loaded with the ASE noise; execute the second sub-operation in a second loading cycle after the first loading cycle, thereby deactivating the one or more second sub-passbands in the optical spectrum for transmission in the fiber optic line; and activate a second AP in a second unoccupied band of the optical spectrum for transmission in the fiber optic line previously occupied by the one or more second sub-passbands, the second AP being loaded with the ASE noise.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a block diagram of an exemplary implementation of an optical transport network constructed in accordance with the present disclosure.

FIG. 2 is a diagram of an exemplary implementation of a computer system shown in FIG. 1 and constructed in accordance with the present disclosure.

FIG. 3A is a block diagram of an exemplary implementation of the network element being a reconfigurable optical add/drop multiplexer constructed in accordance with the present disclosure.

FIG. 3B is a diagram of an exemplary implementation of a light source of FIG. 3A constructed in accordance with the present disclosure.

FIG. 3C is a block diagram of an exemplary implementation of a light sink constructed in accordance with the present disclosure.

FIG. 3D is a diagram of an exemplary implementation of a flexible ROADM module (FRM) constructed in accordance with the present disclosure.

FIG. 4 is a diagram of a comparison of optical power in an optical fiber link for a network element without an ASE source and with the ASE source in accordance with the present disclosure.

FIG. 5 is a diagram of a comparison of total bandwidth between a superchannel containing a plurality of optical carriers and a plurality of discrete passbands containing the plurality of optical carriers in accordance with the present disclosure.

FIGS. 6A-6C are frequency diagrams of a plurality of discrete passbands wherein each of the plurality of discrete passbands contains one of a plurality of optical carriers, a superchannel containing each of the plurality of optical carriers, and a plurality of sub-passbands wherein each of the plurality of sub-passbands contains one of the plurality of optical carriers, wherein the plurality of optical carriers have homogenous (i.e., the same) baud rates in accordance with the present disclosure.

FIGS. 7A-7C are frequency diagrams of a plurality of discrete passbands wherein each of the plurality of discrete passbands contains one of a plurality of optical carriers, a superchannel containing each of the plurality of optical carriers, and a plurality of sub-passbands wherein each of the plurality of sub-passbands contains one of the plurality of optical carriers, wherein the plurality of optical carriers have heterogenous (i.e., different) baud rates in accordance with the present disclosure.

FIGS. 8A-8C are frequency diagrams of a discrete passband containing an optical carrier with a wide bandwidth and a high baud rate, a pair of sub-passbands wherein each of the pair of sub-passbands contains a portion of the optical carrier, and a trio of sub-passbands wherein each of the trio of sub-passbands contains a portion of the optical carrier in accordance with the present disclosure.

FIGS. 9A-9D are frequency diagrams of a superchannel containing a plurality of optical carriers, a plurality of sub-passbands wherein each of the plurality of sub-passbands contains one of the plurality of optical carriers, a plurality of sub-passbands wherein the sub-passbands are distributed such that each of the sub-passbands has the same bandwidth, and plurality of sub-passbands wherein the sub-passbands are distributed such that each of the sub-passbands has an arbitrary bandwidth in accordance with the present disclosure.

FIG. 10 is a frequency diagram of a superchannel containing a plurality of sub-passbands where the boundaries of each of the plurality of sub-passbands are rounded to align with a plurality of channels of the WSS in accordance with the present disclosure.

FIG. 11A is a sequence diagram of a sequence of activating an optical service in an optical transport network using a network element not utilizing sub-passband ramping in accordance with the present disclosure.

FIG. 11B is a graph showing the total optical power in an optical fiber link during the sequence shown in FIG. 11A in accordance with the present disclosure.

FIG. 12A is a sequence diagram of a sequence of activating an optical service in an optical transport network using a network element utilizing sub-passband ramping in accordance with the present disclosure.

FIG. 12B is a graph showing the total optical power in an optical fiber link during the sequence shown in FIG. 12A in accordance with the present disclosure.

FIG. 13A is a sequence diagram of a sequence of deactivating an optical service in an optical transport network using a network element not utilizing sub-passband ramping in accordance with the present disclosure.

FIG. 13B is a graph showing the total optical power in an optical fiber link during the sequence shown in FIG. 13A in accordance with the present disclosure.

FIG. 14A is a sequence diagram of a sequence of deactivating an optical service in an optical transport network using a network element utilizing sub-passband ramping in accordance with the present disclosure.

FIG. 14B is a graph showing the total optical power in an optical fiber link during the sequence shown in FIG. 14A in accordance with the present disclosure.

FIG. 15A is a sequence diagram of a sequence of activating an optical service in an optical transport network using a network element with the ASE source but not utilizing sub-passband ramping in accordance with the present disclosure.

FIG. 15B is a graph showing the total optical power in an optical fiber link during the sequence shown in FIG. 15A in accordance with the present disclosure.

FIGS. 16A and 16B are a sequence diagram of a sequence of activating an optical service in an optical transport network using a network element with the ASE source and utilizing sub-passband ramping in accordance with the present disclosure.

FIG. 16C is a graph showing the total optical power in an optical fiber link during the sequence shown in FIGS. 16A and 16B in accordance with the present disclosure.

### DETAILED DESCRIPTION

The following detailed description of exemplary embodiments refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein are for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise. Further, use of the term “plurality” is meant to convey “more than one” unless expressly stated to the contrary.

As used herein, qualifiers like “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment,” “an embodiment,” “some embodiments,” “one implementation,” “some implementations,” “an implementation,” “one example,” “for example,” or “an example” means that a particular element, feature, structure, or characteristic described in connection with the embodiment/implementation/example is included in at least one embodiment/implementation/example and may be used in conjunction with other embodiments/implementations/examples. The appearance of the phrase “in some embodiments” or “one example” or “in some implementations” in various places in the specification does not necessarily all refer to the same embodiment/implementation/example, for example.

Circuitry, as used herein, may be analog and/or digital components referred to herein as “blocks”, or one or more suitably programmed processors (e.g., microprocessors) and associated hardware and software, or hardwired logic. Also, “components” or “blocks” may perform one or more functions. The term “component” or “block” may include hardware, such as a processor (e.g., a microprocessor), a combination of hardware and software, and/or the like. Software may include one or more processor-executable instructions that when executed by one or more components cause the component to perform a specified function. It should be understood that the algorithms described herein may be stored on one or more non-transitory memory. Exemplary non-transitory memory may include random access memory, read-only memory, flash memory, and/or the like. Such non-transitory memory may be electrically based, optically based, and/or the like.

Software may include one or more processor-readable instruction that when executed by one or more component, e.g., a processor, causes the component to perform a specified function. It should be understood that the algorithms described herein may be stored on one or more non-transitory processor-readable medium, which is also referred to herein as a non-transitory memory. Exemplary non-transitory processor-readable mediums may include random-access memory (RAM), a read-only memory (ROM), a flash memory, and/or a non-volatile memory such as, for example, a CD-ROM, a hard drive, a solid-state drive, a flash drive, a memory card, a DVD-ROM, a Blu-ray Disk, a disk, and an optical drive, combinations thereof, and/or the like. Such non-transitory processor-readable media may be electrically based, optically based, magnetically based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

The generation of laser beams for use as optical data channel signals is explained, for example, in U.S. Pat. No. 8,155,531, titled “Tunable Photonic Integrated Circuits”, issued Apr. 10, 2012, and U.S. Pat. No. 8,639,118, titled “Wavelength division multiplexed optical communication system having variable channel spacings and different modulation formats,” issued Jan. 28, 2014, which are hereby fully incorporated in their entirety herein by reference.

As used herein, an “optical communication path” and/or an “optical route” may correspond to an optical path and/or an optical light path. For example, an optical communication path may specify a path along which light is carried between two or more network entities along a fiber optic link, e.g., an optical fiber.

The optical network has one or more band. A band is the complete optical spectrum carried on the optical fiber. Depending on the optical fiber used and the supported spectrum which can be carried over long distances with the current technology, relevant examples of the same are: C-Band/L-Band/Extended-C-Band. As used herein, the C-Band is a band of light having a wavelength between about 1530 nm and about 1565 nm. The L-Band is a band of light having a wavelength between about 1565 nm and about 1625 nm. Because the wavelength of the C-Band is smaller than the wavelength of the L-Band, the wavelength of the C-Band may be described as a short, or a shorter, wavelength relative to the L-Band. Similarly, because the wavelength of the L-Band is larger than the wavelength of the C-Band, the wavelength of the L-Band may be described as a long, or a longer, wavelength relative to the C-Band.

As used herein, a spectral slice (a “slice”) may represent a spectrum of a particular size in a frequency band (e.g., 12.5 gigahertz (“GHz”), 6.25 GHz, 3.125 GHz, etc.). For example, a 4.8 terahertz (“THz”) frequency band may include 384 spectral slices, where each spectral slice may represent 12.5 GHz of the 4.8 THz spectrum. A slice may be the resolution at which the power levels can be measured by the optical power monitoring device. The power level being measured by the optical power monitoring device represents the total optical power carried by the portion of the band represented by that slice.

Spectral loading, or channel loading, is the addition of one or more channel to a specific spectrum of light described by the light's wavelength in an optical signal. When all channels within a specific spectrum are being utilized, the specific spectrum is described as fully loaded. A grouping of two or more channel may be called a channel group. Spectral loading may also be described as the addition of one or more channel group to a specific spectrum of light described by the light's wavelength to be supplied onto the optical fiber as the optical signal.

A WSS (Wavelength Selective Switch) is a component used in optical communications networks to route (switch) optical signals between optical fibers on a per-slice basis. Generally, power level controls can also be done by the WSS by specifying an attenuation level on a passband filter. A wavelength Selective Switch is a programmable device having source and destination fiber ports where the source and destination fiber ports and associated attenuation can be specified for a particular passband with a minimum bandwidth.

A reconfigurable optical add-drop multiplexer (ROADM) node is an all-optical subsystem that enables remote configuration of wavelengths at any ROADM node. A ROADM is software-provisionable so that a network operator can choose whether a wavelength is added, dropped, or passed through the ROADM node. The technologies used within the ROADM node include wavelength blocking, planar lightwave circuit (PLC), and wavelength selective switching-though the WSS has become the dominant technology. A ROADM system is a metro/regional WDM or long-haul DWDM system that includes a ROADM node. ROADMs are often talked about in terms of degrees of switching, ranging from a minimum of two degrees to as many as eight degrees, and occasionally more than eight degrees. A “degree” is another term for a switching direction and is generally associated with a transmission fiber pair. A two-degree ROADM node switches in two directions, typically called East and West. A four-degree ROADM node switches in four directions, typically called North, South, East, and West. In a WSS-based ROADM network, each degree requires an additional WSS switching element. So, as the directions switched at a ROADM node increase, the ROADM node's cost increases.

An exemplary optical transport network consists of two distinct domains: Layer 0 (“optical domain” or “optical layer”) and Layer 1 (“digital domain”) data planes. Layer 0 is responsible for fixed or reconfigurable optical add/drop multiplexing (R/OADM) and optical amplification (EDFA or Raman) of optical channels and optical channel groups (OCG), typically within the 1530 nm-1565 nm range, known as C-Band. ROADM functions are facilitated via usage of a combination of colorless, directionless, and contentionless (CDC) optical devices, which may include wavelength selective switches (WSS), Multicast switches (MCS). Layer 0 may include the frequency grid (for example, as defined by ITU G.694.1), ROADMs, FOADMs, Amps, Muxes, Line-system and Fiber transmission, and GMPLS Control Plane (with Optical Extensions). Layer 1 functions encompass transporting client signals (e.g., Ethernet, SONET/SDH) in a manner that preserves bit transparency, timing transparency, and delay-transparency. The predominant technology for digital layer data transport in use today is OTN (for example, as defined by ITU G.709). Layer 1 may transport “client layer” traffic. Layer 1 may be a digital layer including multiplexing and grooming. The optical layer may further be divided into either an OTS layer or an OCH layer. The OTS layer refers to the optical transport section of the optical layer, whereas the OCH layer refers to one or more optical channels which are co-routed, e.g., together as multiple channels.

As used herein, a “loading cycle” refers to a structured process of managing and activating and/or deactivating optical passbands. This cycle begins with the presentation of passbands ready for loading, along with their eligible frequency markers, to a loading manager. The loading manager then selects a subset of these passbands, forming a batch to be loaded in a single operation. Following the loading of this batch, adjustments are made in both local and remote control blocks to optimize system performance. This cycle repeats iteratively, with the loading manager continually assessing the pending list of passbands and making loading decisions until no passbands remain pending. The loading cycle allows for dynamic allocation of resources, ensuring that passbands are activated or deactivated as needed while maintaining system stability. The criteria used by the loading manager to determine which passbands to load in each cycle can be based on various factors, such as worst-case SRS estimation, to minimize disruption to existing traffic. This systematic approach to passband management enables the optical line system to adapt to changing network conditions and requirements, ultimately enhancing overall performance and reliability.

An exemplary loading manager is described in U.S. Patent Publication No. 2023/0327762 titled “Method of Transient Management in Optical Transmission Systems”, filed Apr. 7, 2023, and published Oct. 12, 2023, the entire contents of each of which are hereby incorporated herein by reference in its entirety.

The present disclosure relates to systems and methods for decomposing single-carrier and multi-carrier passbands into “sub-passbands”, each having a smaller bandwidth. Each sub-passband is a portion of the optical spectrum within a passband, which may contain one or more sub-passbands. Each sub-passband within a passband may be contiguous to align with the boundaries of the passband.

Activating and/or deactivating services at a sub-passband level allows for more granular control of the amount of the optical spectrum that changes in each loading cycle. Additionally, for systems with ASE idlers, activating and/or deactivating services at the sub-passband level allows for a smoother transition between signal passbands (SPs) and ASE idler passbands (APs) and minimizes the perturbation to the optical multiplexed section (OMS). This holds true for both C-band and C+L band optical line systems.

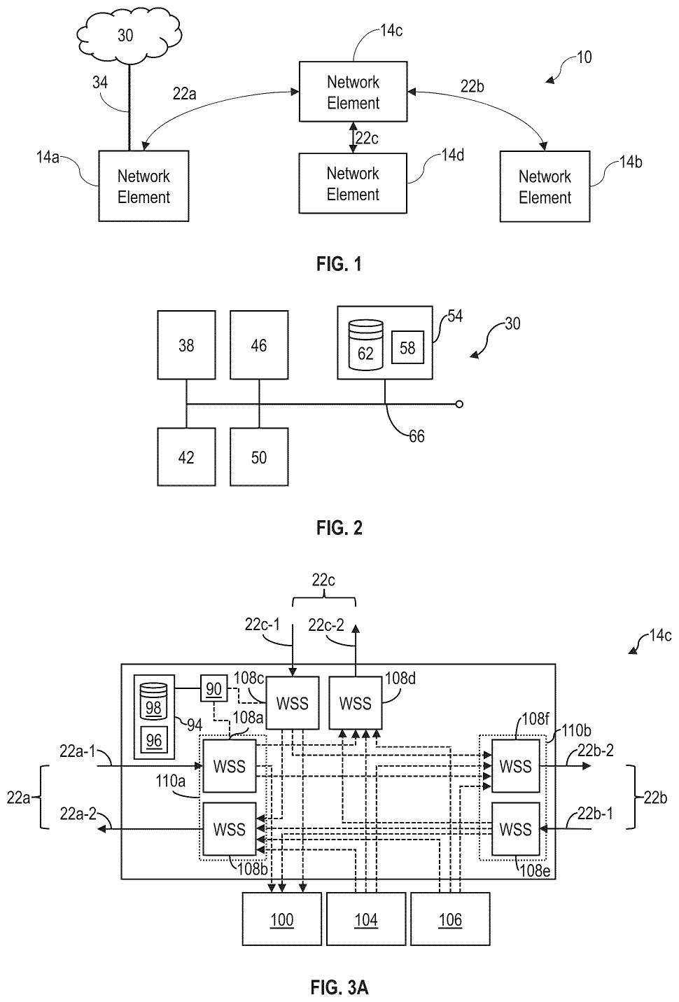

Referring now to the drawings, and in particular to FIG. 1, shown therein is a diagram of an exemplary implementation of an optical transport network 10 constructed in accordance with the present disclosure. The optical transport network 10 is depicted as having a plurality of network elements 14a-n, including a first network element 14a, a second network element 14b, a third network element 14c, and a fourth network element 14d. Though four network elements 14 are shown for exemplary purposes, it will be understood that the plurality of network elements 14a-n may comprise more or fewer network elements 14. Data transmitted within the optical transport network 10 from the first network element 14a to the second network element 14b may travel along an optical path formed from a first optical fiber link 22a, the third network element 14c, and, a second optical fiber link 22b to the second network element 14b.

In one embodiment, a user may interact with a computer system 30, e.g., via a user device, that may be used to communicate with one or more of the network elements 14a-n (hereinafter, the “network element 14”) via a communication network 34.

In some implementations, the computer system 30 (described below in reference to FIG. 2 in more detail) may comprise a processor and a memory having a data store that may store data such as network element version information, firmware version information, sensor data, system data, metrics, logs, tracing, and the like in a raw format as well as transformed data that may be used for tasks such as reporting, visualization, analytics etc. The data store may include structured data from relational databases, semi-structured data, unstructured data, time-series data, and binary data. The data store may be a data base, a remote accessible storage, or a distributed filesystem. In some embodiments, the data store may be a component of an enterprise network.

In some implementations, the computer system 30 is connected to one or more network element 14 via the communication network 34. In this way, the computer system 30 may communicate with each of the one or more network element 14, and may, via the communication network 34 transmit or receive data from each of the one or more network element 14. In other embodiments, the computer system 30 may be integrated into each network element 14 and/or may communicate with one or more pluggable card within the network element 14. In some embodiments, the computer system 30 may be a remote network element.

The communication network 34 may permit bi-directional communication of information and/or data between the computer system 30 and/or the network elements 14 of the optical transport network 10. The communication network 34 may interface with the computer system 30 and/or the network elements 14 in a variety of ways. For example, in some embodiments, the communication network 34 may interface by optical and/or electronic interfaces, and/or may use a plurality of network topographies and/or protocols including, but not limited to, Ethernet, TCP/IP, circuit switched path, combinations thereof, and/or the like. The communication network 34 may utilize a variety of network protocols to permit bi-directional interface and/or communication of data and/or information between the computer system 30 and/or the network elements 14.

The communication network 34 may be almost any type of network. For example, in some embodiments, the communication network 34 may be a version of an Internet network (e.g., exist in a TCP/IP-based network). In one embodiment, the communication network 34 is the Internet. It should be noted, however, that the communication network 34 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like.

If the communication network 34 is the Internet, a primary user interface of the computer system 30 may be delivered through a series of web pages or private internal web pages of a company or corporation, which may be written in hypertext markup language, JavaScript, or the like, and accessible by the user. It should be noted that the primary user interface of the computer system 30 may be another type of interface including, but not limited to, a Windows-based application, a tablet-based application, a mobile web interface, a VR-based application, an application running on a mobile device, and/or the like. In one embodiment, the communication network 34 may be connected to one or more of the user devices, computer system 30, and the network elements 14a-n.

The optical transport network 10 may be, for example, considered as a graph made up of interconnected individual nodes (that is, the network elements 14). If the optical transport network 10 is an optical transport network, the optical transport network 10 may include any type of network that uses light as a transmission medium. For example, the optical transport network 10 may include a fiber-optic based network, an optical transport network, a light-emitting diode network, a laser diode network, an infrared network, a wireless optical network, a wireless network, combinations thereof, and/or other types of optical networks.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of the optical transport network 10 may perform one or more functions described as being performed by another one or more of the devices of the optical transport network 10. Devices of the computer system 30 may interconnect via wired connections, wireless connections, or a combination thereof. For example, in one embodiment, the user device and the computer system 30 may be integrated into the same device, that is, the user device may perform functions and/or processes described as being performed by the computer system 30, described below in more detail.

Referring now to FIG. 2, shown therein is a diagram of an exemplary embodiment of the computer system 30 constructed in accordance with the present disclosure. In some embodiments, the computer system 30 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the computer system 30 may include one or more input devices 38 (hereinafter, the “input device 38”), one or more output devices 42 (hereinafter, the “output device 42”), one or more processors 46 (hereinafter, the “processor 46”), one or more communication devices 50 (hereinafter, the “communication device 50”) capable of interfacing with the communication network 34, one or more non-transitory processor-readable medium (hereinafter, the “computer system memory 54”) storing processor-executable code and/or software application(s) 58, a database 62, for example including, a web browser capable of accessing a website and/or communicating information and/or data over a wireless or wired network (e.g., the communication network 34), and/or the like. The input device 38, the output device 42, the processor 46, the communication device 50, and the computer system memory 54 may be connected via a path 66 such as a data bus that permits communication among the components of the computer system 30.

In some implementations, the processor 46 may comprise one or more processor 46 working together, or independently, to read and/or execute processor executable code and/or data, such as stored in the computer system memory 54. The processor 46 may be capable of creating, manipulating, retrieving, altering, and/or storing data structures into the computer system memory 54. Each element of the computer system 30 may be partially or completely network-based or cloud-based, and may or may not be located in a single physical location.

Exemplary implementations of the processor 46 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 46 may be capable of communicating with the computer system memory 54 via the path 66 (e.g., data bus). The processor 46 may be capable of communicating with the input device 38 and/or the output device 42.

The processor 46 may be further capable of interfacing and/or communicating with the network elements 14 via the communication network 34 using the communication device 50. For example, the processor 46 may be capable of communicating via the communication network 34 by exchanging signals (e.g., analog, digital, optical, and/or the like) via one or more ports (e.g., physical or virtual ports) using a network protocol to provide information to the one or more network element 14.

The computer system memory 54 may store a software application 58 that, when executed by the processor 46, causes the computer system 30 to perform an action such as communicate with, or control, one or more component of the computer system 30, the optical transport network 10 (e.g., the one or more network element 14a-n) and/or the communication network 34. The software application 58 may be an SPCO 200 or one or more service component of the SPCO 200, as described below in more detail.

In some implementations, the computer system memory 54 may be located in the same physical location as the computer system 30, and/or one or more computer system memory 54 may be located remotely from the computer system 30. For example, the computer system memory 54 may be located remotely from the computer system 30 and communicate with the processor 46 via the communication network 34. Additionally, when more than one computer system memory 54 is used, a first computer system memory may be located in the same physical location as the processor 46, and additional computer system memory may be located in a location physically remote from the processor 46. Additionally, the computer system memory 54 may be implemented as a “cloud” non-transitory processor-readable storage memory (i.e., one or more of the computer system memory 54 may be partially or completely based on or accessed using the communication network 34).

In one implementation, the database 62 may be a time-series database, a relational database or a non-relational database. Examples of such databases comprise, DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. The database 62 can be centralized or distributed across multiple systems.

The input device 38 may be capable of receiving information input from the user, another computer, and/or the processor 46, and transmitting such information to other components of the computer system 30 and/or the communication network 34. The input device 38 may include, but is not limited to, implementation as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The output device 42 may be capable of outputting information in a form perceivable by the user, another computer system, and/or the processor 46. For example, implementations of the output device 42 may include, but are not limited to, a computer monitor, a screen, a touchscreen, a speaker, a website, a television set, a smart phone, a PDA, a cell phone, a fax machine, a printer, a laptop computer, a haptic feedback generator, a network interface, combinations thereof, and the like, for example. It is to be understood that in some exemplary embodiments, the input device 38 and the output device 42 may be implemented as a single device, such as, for example, a touchscreen of a computer, a tablet, or a smartphone. It is to be further understood that as used herein the term “user” is not limited to a human being, and may comprise a computer, a server, a website, a processor, a network interface, a user terminal, a virtual computer, combinations thereof, and/or the like, for example.

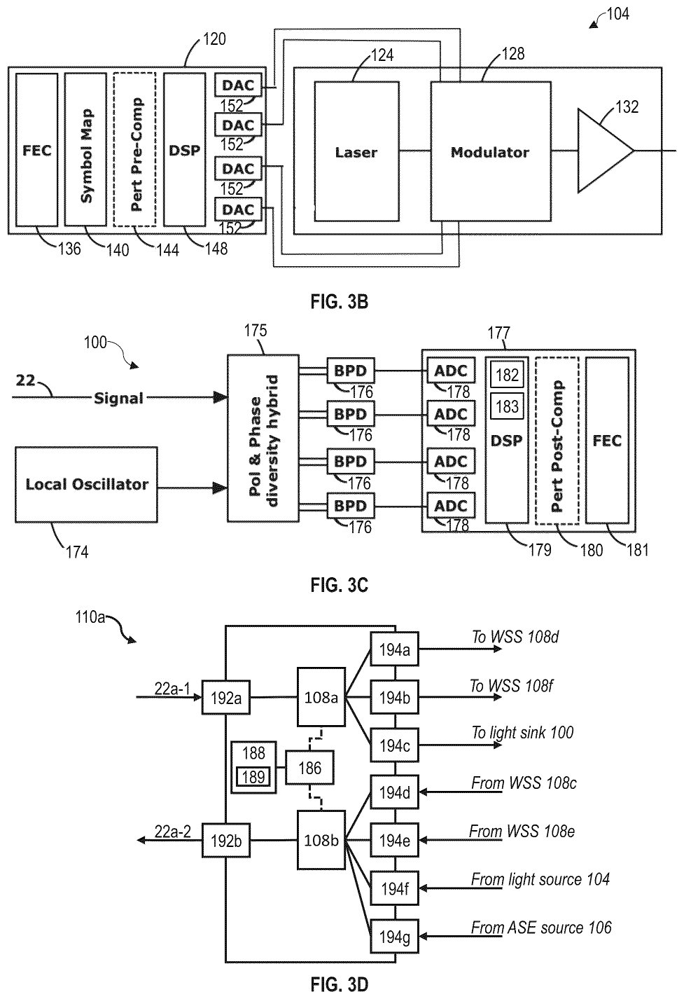

Referring now to FIG. 3A, shown therein is a block diagram of an exemplary implementation of the network element 14 constructed in accordance with the present disclosure. In general, the network element 14 transmits and receives data traffic and control signals.

Nonexclusive examples of alternative implementations of the network element 14 include optical line terminals (OLTs), optical cross connects (OXCs), optical line amplifiers, optical add/drop multiplexer (OADMs) and/or reconfigurable optical add/drop multiplexers (ROADMs), interconnected by way of optical fiber links. OLTs may be used at either end of a connection or optical fiber link. OADM/ROADMs may be used to add, terminate and/or reroute wavelengths or fractions of wavelengths. Optical nodes are further described in U.S. Pat. No. 7,995,921 titled “Banded Semiconductor Optical Amplifiers and Waveblockers”, issued Aug. 9, 2011, U.S. Pat. No. 7,394,953 titled “Configurable Integrated Optical Combiners and Decombiners”, issued Jul. 1, 2008, and U.S. Pat. No. 8,223,803 (Application Publication Number 20090245289), titled “Programmable Time Division Multiplexed Switching,” issued Jul. 17, 2012, the entire contents of each of which are hereby incorporated herein by reference in its entirety. Because SPCO 200 is deployed on a ROADM, as used herein, the network element 14 is implemented as a ROADM unless specifically stated otherwise.

FIG. 3A illustrates an example of the third network element 14c being a ROADM that interconnects the first optical fiber link 22a, the second optical fiber link 22b, and the third optical fiber link 22c. Each of the first optical fiber link 22a, the second optical fiber link 22b, and the third optical fiber link 22c may include optical fiber pairs, wherein each fiber of the pair carries optical signal groups propagating in opposite directions. As seen in FIG. 3A, for example, the first optical fiber link 22a includes a first optical fiber 22a-1, which carries optical signals toward third network element 14c and a second optical fiber 22a-2 that carries optical signals out from the third network element 14c. Similarly, the second optical fiber link 22b may include optical fibers 22b-1 and 22b-2 carrying optical signal groups to and from the third network element 14c, respectively. Further, the third optical fiber link 22c may include first optical fiber 22b-1 and second optical fiber 22b-2 also carrying optical signals to and from the third network element 14c, respectively. Additional nodes, not shown in FIG. 3A, may be provided that supply optical signal groups to and receive optical signal groups from the third network element 14c. Such nodes may also have a ROADM having the same or similar structure as that of the third network element 14c.

As further shown in FIG. 3A, a light sink 100 and a light source 104 may be provided and in communication with the third network element 14c to drop and add optical signal groups, respectively. The light sink 100 is described below in more detail and shown in FIG. 3B. The light source 104 is described below in more detail and shown in FIG. 3C. Optionally, an ASE source 106 may be provided and in communication with the third network element 14c. The ASE source 106 may be configured to generate ASE noise.

As shown in FIG. 3A, the third network element 14c may include a plurality of wavelength selective switches (WSSs 108), such as first, second, third, fourth, fifth, and sixth WSSs 108a-f. Wavelength selective switches are components that can dynamically route, block and/or attenuate received optical signal groups input from and output to optical fiber links 22a-n. In addition to transmitting/receiving optical signal groups from network elements 14, optical signal groups may also be input from or output to the light source 104 and light sink 100, respectively.

In one embodiment, the WSSs 108 for a particular degree, along with associated FRM memory 188 and FRM processor 186 (shown in FIG. 3D), may be collectively referred to as a flexible ROADM module, or FRM 110. For example, as shown in FIG. 3A, a first WSS 108a and a second WSS 108b may be part of a first FRM 110a, and a sixth WSS 108f and a fifth WSS 108e may be part of a third FRM 110c.

In one embodiment, each WSS 108 may include a reconfigurable, optical filter operable to allow a passband (e.g., particular bandwidth of the spectrum of the optical signal) to pass through or be routed as herein described.

As further shown in FIG. 3A, each WSS 108a-f can receive optical signal groups (e.g., optical passbands) and may be operable to selectively switch, or direct, such optical signal groups to other WSSs for output from the third network element 14c. For example, the first WSS 108a may receive optical signal groups on a first optical fiber 22a-1 and supply certain optical signal groups to the sixth WSS 108f, while others are supplied to a fourth WSS 108d. Those supplied to the sixth WSS 108f may be output to a downstream network element 14, such as the second network element 14b (FIG. 1) on a fourth optical fiber 22b-2, while those supplied to the fourth WSS 108d may be output to the fourth network element 14d on a sixth optical fiber 22c-2. Also, optical signal groups input to the third network element 14c on a third optical fiber 22b-1 may be supplied by the fifth WSS 108e to either the second WSS 108b and on to the first network element 14a via the second optical fiber 22a-2 or the fourth WSS 108d and on to the fourth network element 14d via the sixth optical fiber 22c-2. Moreover, the third WSS 108c may selectively direct optical signal groups (e.g., selectively switch optical passband groups) input to the third network element 14c from the fifth optical fiber 22c-1 to either the second WSS 108b and onto the first network element 14a via the second optical fiber 22a-2 or to the sixth WSS 108f and onto the second network element 14b via the fourth optical fiber 22b-2.

The first WSS 108a, the third WSS 108c, and the fifth WSS 108e may also selectively or controllably supply optical signal groups to the light sink 100 and optical signal groups may be selectively output from the light source 104 in the third network element 14c. The optical signal groups output from the light source 104 may be selectively supplied to one or more of the second WSS 108b, the fourth WSS 108d, and the sixth WSS 108f, for output on to the second optical fiber 22a-2, the fourth optical fiber 22b-2, and the sixth optical fiber 22c-2, respectively.

In one implementation, the third network element 14c may further comprise a node processor 90 and a non-transitory computer readable medium referred to herein as node memory 94. The node processor 90 may include, but is not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The node processor 90 is in communication with the node memory 94 and may be operable to read and/or write to the node memory 94. The node processor 90 may be capable of communicating with one or more of the WSSs 108 (shown as in communication with the third WSS 108c and the first WSS 108a for simplicity, however, the node processor 90 may be in communication with each WSS 108) or each FRM 110. The node processor 90 may be further capable of interfacing and/or communicating with the network elements 14 via the communication network 34. For example, the node processor 90 may be capable of communicating via the communication network 34 by exchanging signals (e.g., analog, digital, optical, and/or the like) via one or more ports (e.g., physical or virtual ports) using a network protocol to provide information to the one or more network element 14. In one embodiment, the node processor 90 may be referred to as a node processor and the node memory 94 may be referred to as a node memory 94.

In one implementation, the node memory 94 of the network element 14, such as of the third network element 14c, may store a software application 96, such as an orchestrator application (e.g., the SPCO 200 or one or more service component of the SPCO 200 such as orchestrator 202, described below in more detail) that, when executed by the node processor 90, causes the node processor 90 to perform an action, for example, communicate with or control one or more component of the network element 14 such as control one or more of the WSS 108 or the FRM 110.

In one implementation, the node memory 94 may store one or more of the datastore 98. The datastore 98 may include, for example, structured data from relational databases, semi-structured data, unstructured data, time-series data, binary data, and the like and/or some combination thereof. The datastore 98 may be a data base, a remote accessible storage, or a distributed filesystem. In some embodiments, the datastore 98 may be a component of an enterprise network.

Referring now to FIG. 3B, shown therein is a diagram of an exemplary implementation of the light source 104 of FIG. 3A constructed in accordance with the present disclosure. The light source 104 may comprise one or more transmitter processor circuit 120, one or more laser 124, one or more modulator 128, one or more semiconductor optical amplifier 132, and/or other components (not shown).

The transmitter processor circuit 120 may have a Transmitter Forward Error Correction (FEC) circuitry 136, a Symbol Map circuitry 140, a transmitter perturbative pre-compensation circuitry 144, one or more transmitter digital signal processor (DSP) 148, and one or more digital-to-analogue converters (DAC) 152. The transmitter processor circuit 120 may be located in any one or more components of the light source 104, or separate from the components, and/or in any location(s) among the components. The transmitter processor circuit 120 may be in the form of one or more Application Specific Integrated Circuit (ASIC), which may contain one or more module and/or custom module.

Processed electrical outputs from the transmitter processor circuit 120 may be supplied to the modulator 128 for encoding data into optical signals generated and supplied to the modulator 128 from the laser 124. The semiconductor optical amplifier 132 receives, amplifies, and transmits the optical signal including encoded data in the spectrum. Processed electrical outputs from the transmitter processor circuit 120 may be supplied to other circuitry in the transmitter processor circuit 120, for example, clock and data modification circuitry. The laser 124, modulator 128, and/or semiconductor optical amplifier 132 may be coupled with a tuning element (e.g., a heater) (not shown) that can be used to tune the wavelength of an optical signal channel output by the laser 124, modulator 128, or semiconductor optical amplifier 132. In some implementations, a single one of the laser 124 may be shared by multiple light source 104.

Other possible components in the light source 104 may include filters, circuit blocks, memory, such as non-transitory memory storing processor executable instructions, additional modulators, splitters, couplers, multiplexers, etc., as is well known in the art. The components may be combined, used, or not used, in multiple combinations or orders. Optical transmitters are further described in U.S. Patent Publication No. 2012/0082453, the content of which is hereby incorporated by reference in its entirety herein.

Referring now to FIG. 3C, shown therein is a block diagram of an exemplary implementation of the light sink 100 constructed in accordance with the present disclosure. The light sink 100 may comprise one or more local oscillator 174, a polarization and phase diversity hybrid circuit 175 receiving the one or more channel from the optical signal and the input from the local oscillator 174, one or more balanced photodiode 176 that produces electrical signals representative of the one or more channel on the spectrum, and one or more receiver processor circuit 177. Other possible components in the light sink 100 may include filters, circuit blocks, memory, such as non-transitory processor-readable memory storing processor-executable instructions, additional modulators, splitters, couplers, multiplexers, etc., as is well known in the art. The components may be combined, used, or not used, in multiple combinations or orders. The light sink 100 may be implemented in other ways, as is well known in the art. Exemplary implementations of the light sink 100 are further described in U.S. Pat. No. 8,014,686, titled “Polarization Demultiplexing Optical Receiver Using Polarization Oversampling and Electronic Polarization Tracking”, issued on Sep. 6, 2011, the entire contents of which are hereby incorporated herein by reference.

The one or more receiver processor circuit 177, may comprise one or more analog-to-digital converter (ADC) 178 receiving the electrical signals from the balanced photodiodes 176, one or more receiver digital signal processor (DSP) 179, receiver perturbative post-compensation circuitry 180, and receiver forward error correction (FEC) circuitry 181. The receiver FEC circuitry 181 may apply corrections to the data, as is well known in the art. The one or more receiver processor circuit 177 and/or the one or more receiver DSP 179 may be located on one or more component of the light sink 100 or separately from the components, and/or in any location(s) among the components. The receiver processor circuit 177 may be in the form of an Application Specific Integrated Circuit (ASIC), which may contain one or more module and/or custom module. In one embodiment, the receiver DSP 179 may include, or be in communication with, one or more processor 182 and one or more memory 183 storing processor readable instructions, such as software, or may be in communication with the node processor 90 and the node memory 94.

The one or more receiver DSP 179 may receive and process the electrical signals with multi-input-multiple-output (MIMO) circuitry, as described, for example, in U.S. Pat. No. 8,014,686, titled “Polarization demultiplexing optical receiver using polarization oversampling and electronic polarization tracking”, the entire contents of which are hereby incorporated by reference herein. Processed electrical outputs from receiver DSP 179 may be supplied to other circuitry in the receiver processor circuit 177, such as the receiver perturbative post-compensation circuitry 180 and the receiver FEC circuitry 181.

Various components of the light sink 100 may be provided or integrated, in one example, on a common substrate. Further integration is achieved by incorporating various optical demultiplexer designs that are relatively compact and conserve space on the surface of the substrate.

In use, the one or more channel of the spectrum may be subjected to optical non-linear effects between the light source 104 and the light sink 100 such that the spectrum received does not accurately convey carried data in the form that the spectrum was transmitted. The impact of optical nonlinear effects can be partially mitigated by applying perturbative distortion algorithms using one or more of the transmitter perturbative pre-compensation circuitry 171 and the receiver perturbative post-compensation circuitry 180. The amount of perturbation may be calculated using coefficients in algorithms and known or recovered transmitted data. The coefficients may be calculated, in accordance with U.S. Pat. No. 9,154,258 titled “Subsea Optical Communication System Dual Polarization Idler”, herein incorporated by reference in its entirety, by use of analysis of one or more incoming channel at the light sink 100.

Referring now to FIG. 3D, shown therein is a diagram of an exemplary implementation of the first FRM 110a constructed in accordance with the present disclosure. The first FRM 110a generally comprises a FRM processor 186 in communication with a FRM memory 188, the first WSS 108a, and the second WSS 108b. The first WSS 108a is in optical communication with a first line port 192a operable to receive the optical signal from the first optical fiber 22a-1 and is in optical communication with two or more system ports 194 (shown in FIG. 3D as a first system port 194a, a second system port 194b, and a third system port 194c) to selectively output one or more passband to one or more of the system ports 194. The second WSS 108b is in optical communication with a second line port 192b operable to output an optical signal to the optical fibers 22a-b and is in optical communication with two or more system ports 194 (shown in FIG. 3D as fourth system port 194d, fifth system port 194e, sixth system port 194f, and seventh system port 194g) to selectively output one or more passband to the second line port 192b. In one embodiment, the first WSS 108a (as well as other wavelength selective switches demultiplexing an incoming optical signal such as the third WSS 108c and the fifth WSS 108e) may be considered a DEMUX WSS and the second WSS 108b (as well as other wavelength selective switches multiplexing one or more incoming optical signal into an optical signal output to an optical fiber link 22, such as the fourth WSS 108d and the sixth WSS 108f) may be considered a MUX WSS. The number of components illustrated in FIG. 3D is provided for explanatory purposed. In practice, there may be additional components, such as one or more EDFA, fewer components, different components, and/or differently arranged components than shown in FIG. 3D.

In one implementation, each of the system ports 194a-n may have a port type of either an express port or an add/drop port. For example, the first system port 194a, optically coupled to the fourth WSS 108d, and the second system port 194b, optically coupled to the sixth WSS 108f, may have a port type of express port and may be considered express ports, while the third system port 194c, optically coupled to the light sink 100, may have a port type of add/drop port and may be considered a drop port. Similarly, the fourth system port 194d, optically coupled to the third WSS 108c, and the fifth system port 194e, optically coupled to the fifth WSS 108e, may have a port type of express port and may be considered express ports, while the sixth system port 194f, optically coupled to the light source 104, may have a port type of add/drop port and may be considered an add port, and the seventh system port 194g, optically coupled to the ASE source 106, may have a port type of add/drop port and may be considered an add port.

In one implementation, the first FRM 110a is a C-Band FRM, that is, the components of the first FRM 110a operate on the C-Band of the optical spectrum. In other embodiments, the first FRM 110a is an L-Band FRM, that is, the components of the first FRM 110a operate on the L-Band of the optical spectrum. In yet another implementation, the first FRM 110a is a C+L-Band FRM having components that operate on the C-Band and the L-Band. The number of devices illustrated in FIG. 3D is provided for explanatory purposes. In practice, there may be additional devices, fewer devices, different devices, or differently arranged devices than are shown in FIG. 3D. Furthermore, two or more of the devices illustrated in FIG. 3D may be implemented within a single device, or a single device illustrated in FIG. 3D may be implemented as multiple, distributed devices. For example, the C+L-Band FRM may comprise an L-Band FRM optically coupled to a C-Band FRM.

In one implementation, the FRM memory 188 may be constructed in accordance with the computer system memory 54 and/or the node memory 94 as described above in more detail. The FRM memory 188 may comprise a non-transitory processor-readable medium storing processor-executable instructions such as a FRM software application 189. The FRM software application 189 includes instructions that, when executed by the FRM processor 186, cause the FRM processor 186 to control the first WSS 108a and/or the second WSS 108b.

In a first aspect, an incoming optical signal having multiple optical channels enters the first line port 192a via the first optical fiber 22a-1 and is directed to the first WSS 108a. The incoming optical signal is split into one or more segments by the first WSS 108a, each segment having one or more optical channel. The one or more segments of the incoming optical signal are then directed to one or more system port 194a-c, for example, the first WSS 108a may direct one or more segment to one or more of the fourth WSS 108d via the first system port 194a, the sixth WSS 108f via the second system port 194b, and/or the light sink 100 via the third system port 194c.

In a second aspect, a first incoming optical signal enters the fourth system port 194d, a second incoming optical signal enters the fifth system port 194e, a third incoming optical signal enters the sixth system port 194f, and an ASE noise signal enters the seventh system port 194g, and each incoming optical signal or ASE noise signal is directed to the second WSS 108b. The second WSS 108b, as directed by the FRM processor 186, may combine the first incoming optical signal, the second incoming optical signal, the third incoming optical signal, and the ASE noise signal into a combined optical signal that is sent on the second optical fiber 22a-2 via the second line port 192b. For example, the second WSS 108b may receive the first incoming optical signal from the third WSS 108c via the fourth system port 194d, the second incoming optical signal from the fifth WSS 108e via the fifth system port 194e, the third incoming optical signal from the light source 104 via the sixth system port 194f, and the ASE noise signal from the ASE source 106 via the seventh system port 194g.

While each of the above aspects and the illustration of the first WSS 108a and the second WSS 108b in FIG. 3D show the first WSS 108a and the second WSS 108b with only three of the system ports 194, a person having ordinary skill in the art would recognize that the first WSS 108a and the second WSS 108b may have as few as two system ports 194 and as many system ports 194 as the WSS 108 is operable to selectively output or combine. In some embodiments, each WSS 108 may have any number of system ports 194 in a range of 2 and 16 system ports 194.

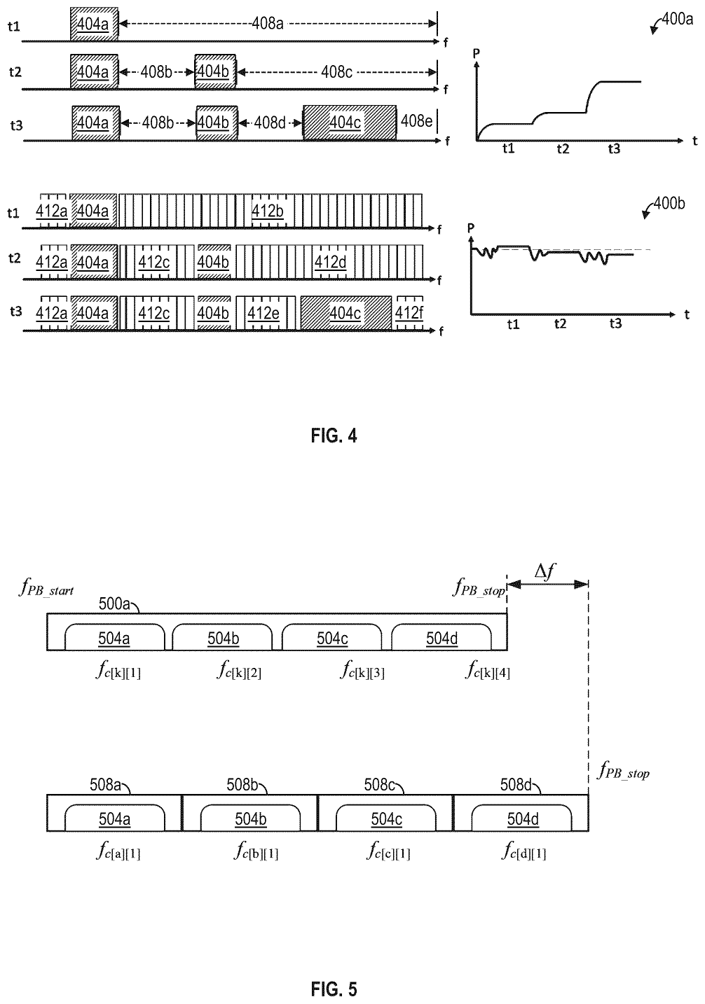

Referring now to FIG. 4, shown therein is a comparison of optical power in an optical fiber link 22 across three time instances for a network element 14 without the ASE source 106 (indicated by reference character 400a) and with the ASE source 106 (indicated by reference character 400b) as the network element 14 activates a first SP 404a at a first time instance t1, a second SP 404b at a second time instance t2, and a third SP 404c at a third time instance t3.

After the network element 14 without the ASE source 106 (indicated by reference character 400a) activates each of the first SP 404a at the first time instance t1, the second SP 404b at the second time instance t2, and the third SP 404c at the third time instance t3, the optical power in the optical fiber link increases significantly. Further, after the network element 14 without the ASE source 106 has finished activating each of the first SP 404a, the second SP 404b, and the third SP 404c, one or more gaps 408 may remain in the optical spectrum. That is, a first gap 408a remains in the optical spectrum at the first time instance t1, a second gap 408b and a third gap 408c remain in the optical spectrum at the second time instance t2, and the second gap 408b, a fourth gap 408d, and a fifth gap 408e remain in the optical spectrum at the third time instance t3.

After the network element 14 with the ASE source 106 (indicated by reference character 400b) activates each of the first SP 404a at the first time instance t1, the second SP 404b at the second time instance t2, and the third SP 404c at the third time instance t3, the optical power in the optical fiber link varies only slightly. Further, as the network element 14 with the ASE source 106 activates each of the first SP 404a, the second SP 404b, and the third SP 404c, the network element 14 with the ASE source 106 ensures that each of the gaps 408 in the optical spectrum is filled with one or more APs 412 by activating one or more first APs 412a and one or more second APs 412b at the first time instance t1, one or more third APs 412c and one or more fourth APs 412d at the second time instance t2, and one or more fifth APs 412e and one or more sixth APs 412f at the third time instance t3.

In some implementations, after filling the gaps 408 with the APs 412, the network element 14 with the ASE source 106 may carve out portions of the spectrum by deactivating some of the APs 412 to make space for the SPs 404 before activating the SPs 404. For example, at least one of the one or more second APs 412b is deactivated at the second time instance t2 to make space for the second SP 404b before activating the second SP 404b, and at least one of the one or more fourth APs 412d is deactivated at the third time stance t3 to make space for the third SP 404c before activating the third SP 404c.

Referring now to FIG. 5, shown therein is a comparison between a first superchannel 500a containing a plurality of optical carriers 504 including a first optical carrier 504a, a second optical carrier 504b, a third optical carrier 504c, and a fourth optical carrier 504d and a plurality of discrete passbands 508 including a first discrete passband 508a containing the first optical carrier 504a, a second discrete passband 508b containing the second optical carrier 504b, a third discrete passband 508c containing the third optical carrier 504c, and a fourth discrete passband 508d containing the fourth optical carrier 504d.

As shown in FIG. 5, although the optical carriers 504 contained in each of the discrete passbands 508 occupy the same amount of optical bandwidth as the optical carriers 504 contained in the first superchannel 500a, each of the discrete passbands 508 requires additional guardbands to support individual filtering and routing at ROADM and FOADM sites, leading to an increase in total bandwidth of Δf over the first superchannel 500a.

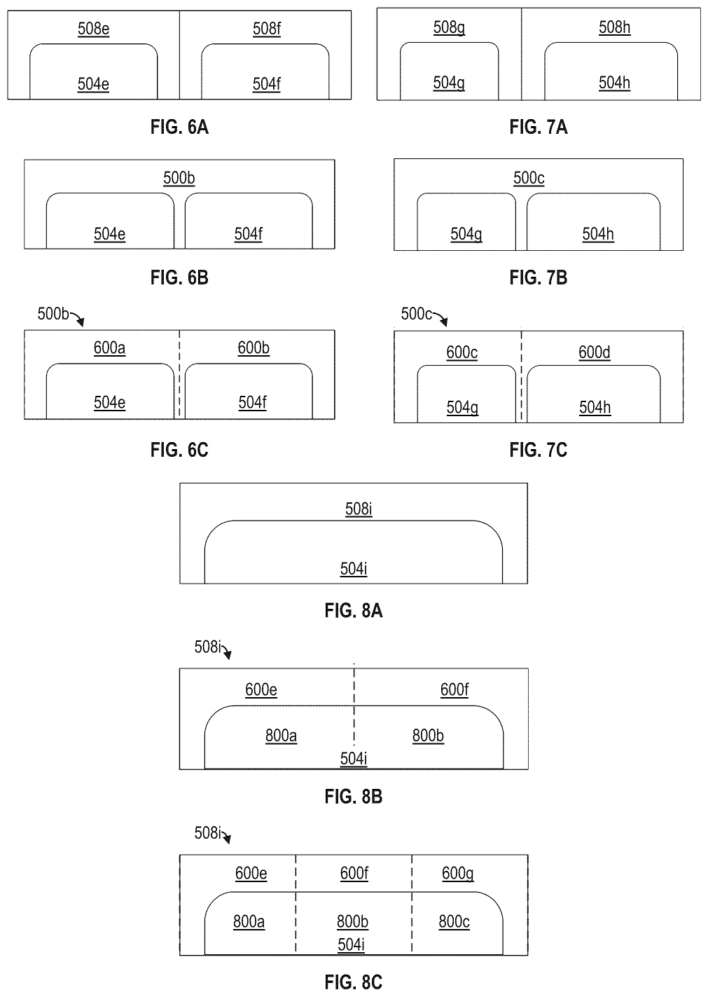

Referring now to FIGS. 6A-6C, shown therein are a fifth first discrete passband 508e containing a fifth optical carrier 504e and a sixth discrete passband 508f containing a sixth optical carrier 504f, wherein the fifth optical carrier 504e and the sixth optical carrier 504f have homogenous (i.e., the same) baud rates (shown in FIG. 6A), a second superchannel 500b containing the fifth optical carrier 504e and the sixth optical carrier 504f (shown in FIG. 6B), and the second superchannel 500b containing a first sub-passband 600a containing the fifth optical carrier 504e and a second sub-passband 600b containing the sixth optical carrier 504f (shown in FIG. 6C).

Referring now to FIGS. 7A-7C, shown therein are a seventh discrete passband 508g containing a seventh optical carrier 504g and an eighth discrete passband 508h containing an eighth optical carrier 504h, wherein the seventh optical carrier 504g and the eighth optical carrier 504h have heterogenous (i.e., different) baud rates (shown in FIG. 7A), a third superchannel 500c containing the seventh optical carrier 504g and the eighth optical carrier 504h (shown in FIG. 7B), and the third superchannel 500c containing a third sub-passband 600c containing the seventh optical carrier 504g and a fourth sub-passband 600d containing the eighth optical carrier 504h (shown in FIG. 7C).

Referring now to FIGS. 8A-8C, shown therein are a ninth discrete passband 508i containing a ninth optical carrier 504i, wherein the ninth optical carrier 504i has a wide bandwidth and a high baud rate (shown in FIG. 8A), the ninth discrete passband 508i containing a fifth sub-passband 600e containing a first portion 800a of the ninth optical carrier 504i and a sixth sub-passband 600f containing a second portion 800b of the ninth optical carrier 504i (shown in FIG. 8B), and the ninth discrete passband 508i containing the fifth sub-passband 600e containing the first portion 800a of the ninth optical carrier 504i, the sixth sub-passband 600f containing the second portion 800b of the ninth optical carrier 504i, and a seventh sub-passband 600g containing a third portion 800c of the ninth optical carrier 504i (shown in FIG. 8C).

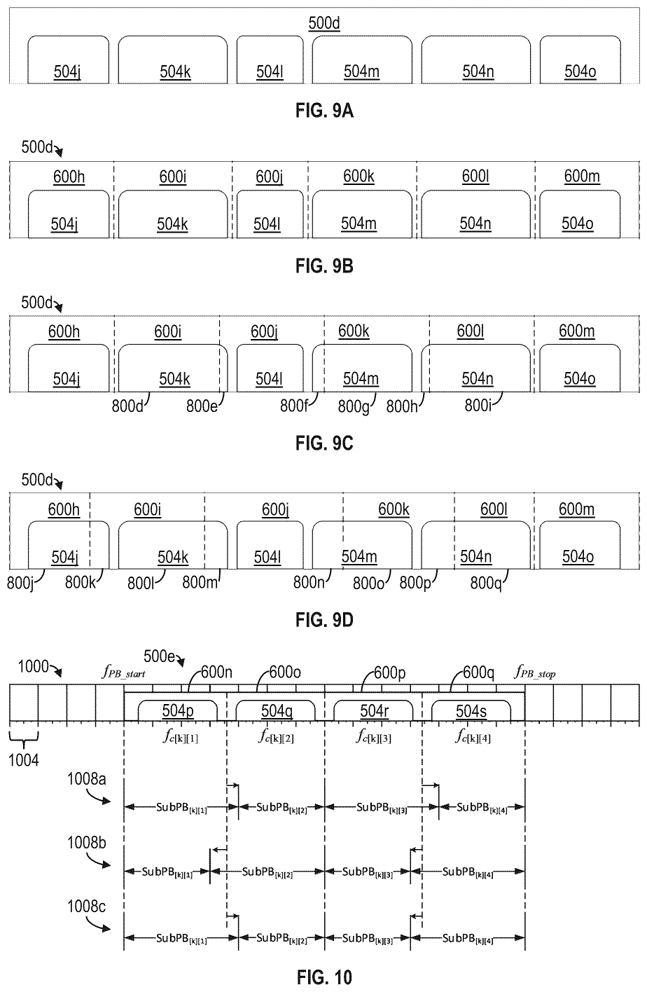

Referring now to FIG. 9A, shown therein is a fourth superchannel 500d containing a tenth optical carrier 504j, an eleventh optical carrier 504k, a twelfth optical carrier 504l, a thirteenth optical carrier 504m, a fourteenth optical carrier 504n, and a fifteenth optical carrier 5040.

Referring now to FIG. 9B, shown therein is the fourth superchannel 500d containing an eighth sub-passband 600h containing the tenth optical carrier 504j, a ninth sub-passband 600i containing the eleventh optical carrier 504k, a tenth sub-passband 600j containing the twelfth optical carrier 504l, an eleventh sub-passband 600k containing the thirteenth optical carrier 504m, a twelfth sub-passband 600l containing the fourteenth optical carrier 504n, and a thirteenth sub-passband 600m containing the fifteenth optical carrier 5040, wherein the sub-passbands 600 are distributed such that each of the sub-passbands 600 contains a single one of the optical carriers 504.

Referring now to FIG. 9C, shown therein is the fourth superchannel 500d containing the eighth sub-passband 600h containing the tenth optical carrier 504j, the ninth sub-passband 600i containing a fourth portion 800d of the eleventh optical carrier 504k, a tenth sub-passband 600j containing a fifth portion 800e of the eleventh optical carrier 504k, the twelfth optical carrier 504l, and a sixth portion 800f of the thirteenth optical carrier 504m, an eleventh sub-passband 600k containing a seventh portion 800g of the thirteenth optical carrier 504m and an eighth portion 800h of the fourteenth optical carrier 504n, a twelfth sub-passband 600l containing a ninth portion 800i of the fourteenth optical carrier 504n, and a thirteenth sub-passband 600m containing the fifteenth optical carrier 5040, wherein the sub-passbands 600 are distributed such that each of the sub-passbands 600 has the same bandwidth.

Referring now to FIG. 9D, shown therein is the fourth superchannel 500d containing the eighth sub-passband 600h containing a tenth portion 800j of the tenth optical carrier 504j, the ninth sub-passband 600i containing an eleventh portion 800k of the tenth optical carrier 504j and a twelfth portion 800l of the eleventh optical carrier 504k, the tenth sub-passband 600j containing a thirteenth portion 800m of the eleventh optical carrier 504k, the twelfth optical carrier 504l, and a fourteenth portion 800n of the thirteenth optical carrier 504m, the eleventh sub-passband 600k containing a fifteenth portion 8000 of the thirteenth optical carrier 504m and a sixteenth portion 800p of the fourteenth optical carrier 504n, the twelfth sub-passband 600l containing a seventeenth portion 800q of the fourteenth optical carrier 504n, and the thirteenth sub-passband 600m containing the fifteenth optical carrier 5040, wherein the sub-passbands 600 are distributed such that each of the sub-passbands 600 has an arbitrary bandwidth.

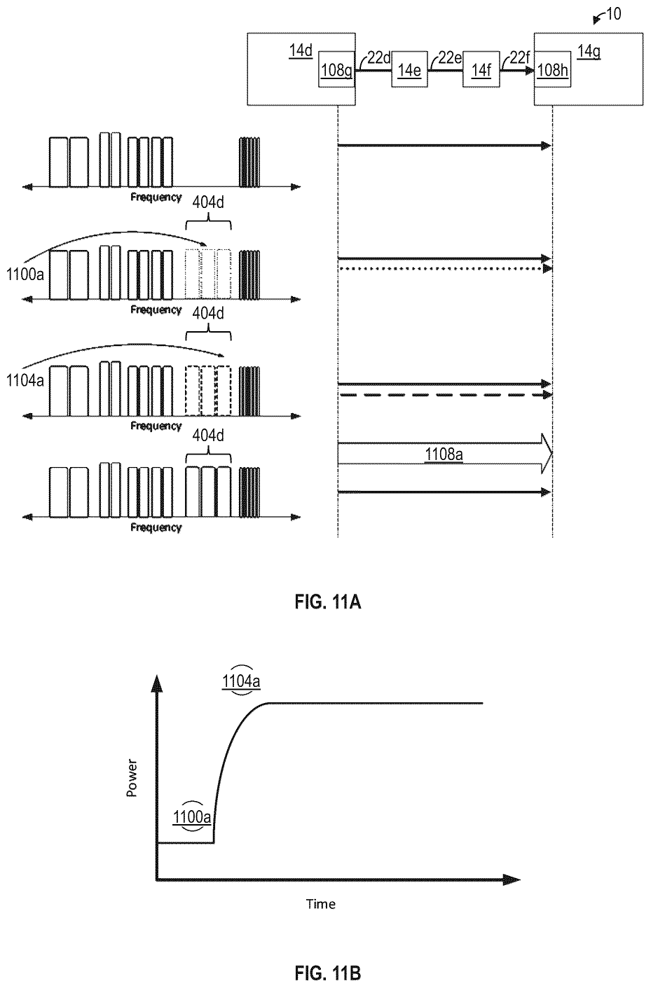

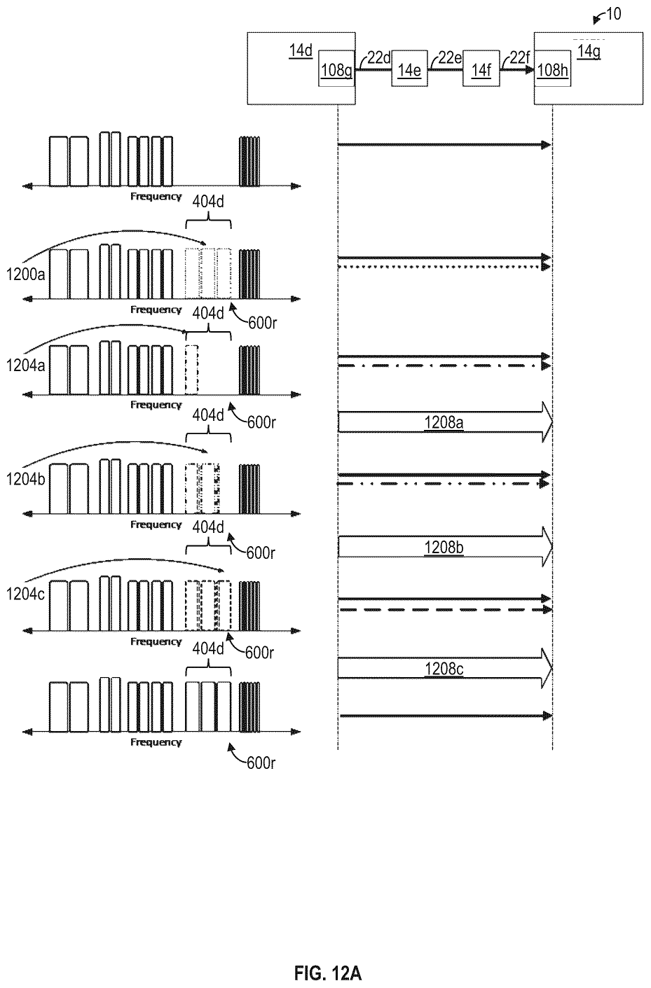

Referring now to FIG. 10, shown therein is a fifth superchannel 500e containing a fourteenth sub-passband 600n containing a sixteenth optical carrier 504p, a fifteenth sub-passband 600o containing a seventeenth optical carrier 504q, a sixteenth sub-passband 600p containing an eighteenth optical carrier 504r, and a seventeenth sub-passband 600q containing a nineteenth optical carrier 504s.

It should be understood that, while the boundaries (i.e., the start frequency and the end frequency) of each of the sub-passbands 600 are not restricted to any particular frequencies, they may align with a predetermined frequency grid 1000 having a plurality of channels 1004 with a bandwidth equal to or greater than the minimum channel bandwidth of the WSS 108. For purposes of clarity, only one of the channels 1004 is labelled with a reference character.

In some implementations, the predetermined frequency grid 1000 conforms to a Dense Wavelength Division Multiplexing (DWDM) frequency grid defined by Recommendation G.694.1, Edition 3.0, approved by the International Telecommunication Union (ITU) Telecommunication Standardization Sector (ITU-T) on Oct. 29, 2020. In other implementations, the predetermined frequency grid 1000 has an anchor frequency a and a plurality of central frequencies f_{c}, each of the plurality of central frequencies being determined based on the formula f_{c}[n]=a+m×n, where m is the minimum channel bandwidth of the WSS 108 and n is an integer. In some implementations, the anchor frequency a is 193.1 THz. The minimum channel bandwidth m of the WSS 108 may be one of 3.125 GHz, 6.25 GHz, 10 GHz, 12.5 GHz, 25 GHz, 50 GHz, and 100 GHz.

In order to align the boundaries of each of the sub-passbands 600 with the boundaries of the channels 1004 of the predetermined frequency grid 1000, the sub-passbands 600 may be adjusted in a number of different ways. Further shown in FIG. 10 are a plurality of different methods 1008 for aligning the boundaries of each of the sub-passbands 600 with the boundaries of the channels 1004 of the predetermined frequency grid 1000, including a first method 1008a wherein the boundaries of the sub-passbands 600 are rounded up to align with the boundaries of the channels 1004 of the predetermined frequency grid 1000, a second method 1008b wherein the boundaries of the sub-passbands 600 are rounded down to align with the boundaries of the channels 1004 of the predetermined frequency grid 1000, and a third method 1008c wherein the boundaries of the sub-passbands 600 are rounded up or down to align with the nearest boundaries of the channels 1004 of the predetermined frequency grid 1000.

It should be understood that other methods may be used to align the boundaries of each of the sub-passbands 600 with the boundaries of the channels 1004 of the predetermined frequency grid 1000.

Referring now to FIG. 11A, shown therein is an exemplary implementation of a sequence of activating an optical service in the optical transport network 10 using the network element 14 not utilizing sub-passband 600 ramping in accordance with the present disclosure. As shown in FIG. 11A, a user or the computer system 30 provisions a fourth SP 404d to activate an optical service (indicated by reference character 1100a), and the network element 14 performs the operation by activating the fourth SP 404d in a first loading cycle (indicated by reference character 1104a), performing a first automatic gain control (AGC) cycle (indicated by reference character 1108a) and/or adjusting one or more amplifier gain and/or tilt setpoints if necessary, and completing activation of the optical service.

As shown in FIG. 11B, when the network element 14 not utilizing sub-passband 600 ramping activates the fourth SP 404d in the first loading cycle (indicated by reference character 1104a), the total optical power in the optical fiber link 22d-f increases substantially in a single step.

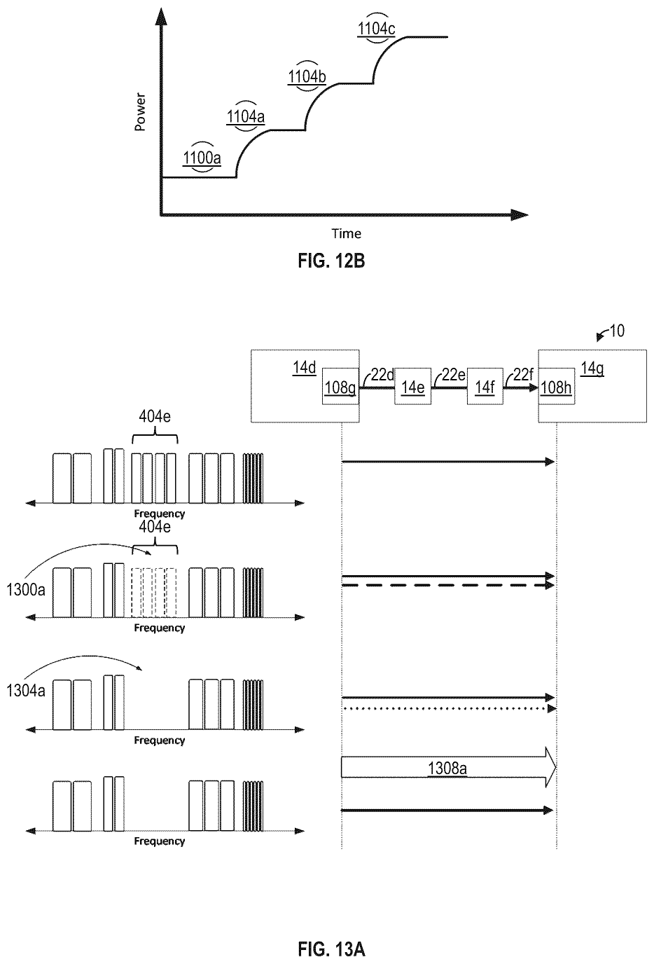

Referring now to FIG. 12A, shown therein is an exemplary implementation of a sequence of activating an optical service in the optical transport network 10 utilizing sub-passband 600 ramping in accordance with the present disclosure. As shown in FIG. 12A, the user or the computer system 30 provisions the fourth SP 404d to activate the optical service (indicated by reference character 1200a), and the network element 14 divides the loading operation into a plurality of sub-operations, including activating one of a plurality of seventeenth sub-passbands 600r in the first loading cycle (indicated by reference character 1204a), performing the first AGC cycle (indicated by reference character 1208a) and/or adjusting one or more amplifier gain and/or tilt setpoints if necessary, activating another of the plurality of seventeenth sub-passbands 600r in a second loading cycle (indicated by reference character 1204b), performing a second AGC cycle (indicated by reference character 1208b) and/or adjusting one or more amplifier gain and/or tilt setpoints if necessary, activating the last of the plurality of seventeenth sub-passbands 600r in a third loading cycle (indicated by reference character 1204c), performing a third AGC cycle (indicated by reference character 1208c) and/or adjusting one or more amplifier gain and/or tilt setpoints if necessary, and completing activation of the optical service.

As shown in FIG. 12B, when the network element 14 utilizing sub-passband 600 ramping activates each of the plurality of seventeenth sub-passbands 600r in the first loading cycle (indicated by reference character 1204a), the second loading cycle (indicated by reference character 1204b), and the third loading cycle (indicated by reference character 1204c), the total optical power in the optical fiber link 22d-f increases by the same amount, but because the network element is able to perform AGC cycles and adjust one or more amplifier gain and/or tilt setpoint between each loading cycle, if necessary, the total accumulated perturbation from activating the fourth SP 404d is minimized. As further shown in FIG. 12B, this results in the total optical power in the optical fiber link 22d-f increasing only slightly in each step.

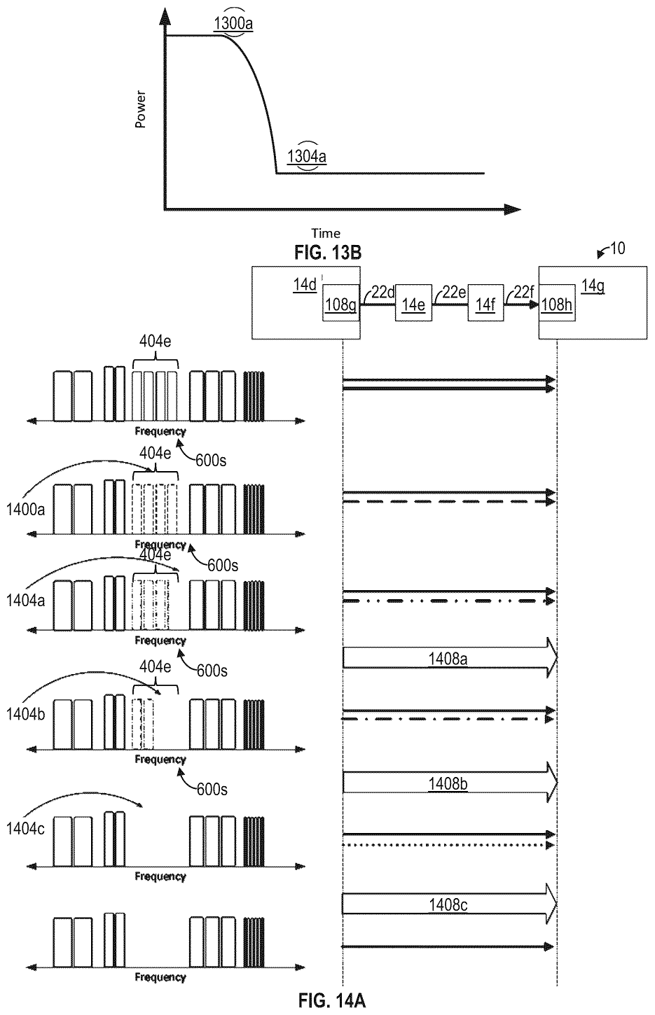

Referring now to FIG. 13A, shown therein is an exemplary implementation of a sequence of deactivating an optical service in the optical transport network 10 using the network element 14 not utilizing sub-passband 600 ramping in accordance with the present disclosure. As shown in FIG. 13A, a user or the computer system 30 provisions a fifth SP 404e to deactivate an optical service (indicated by reference character 1300a), and the network element 14 performs the operation by deactivating the fifth SP 404e in a first loading cycle (indicated by reference character 1304a), performing a first AGC cycle (indicated by reference character 1308a) and/or adjusting one or more amplifier gain and/or tilt setpoints if necessary, and completing deactivation of the optical service.

As shown in FIG. 13B, when the network element 14 not utilizing sub-passband 600 ramping deactivates the fifth SP 404e in the first loading cycle (indicated by reference character 1304a), the total optical power in the optical fiber link 22d-f decreases substantially.

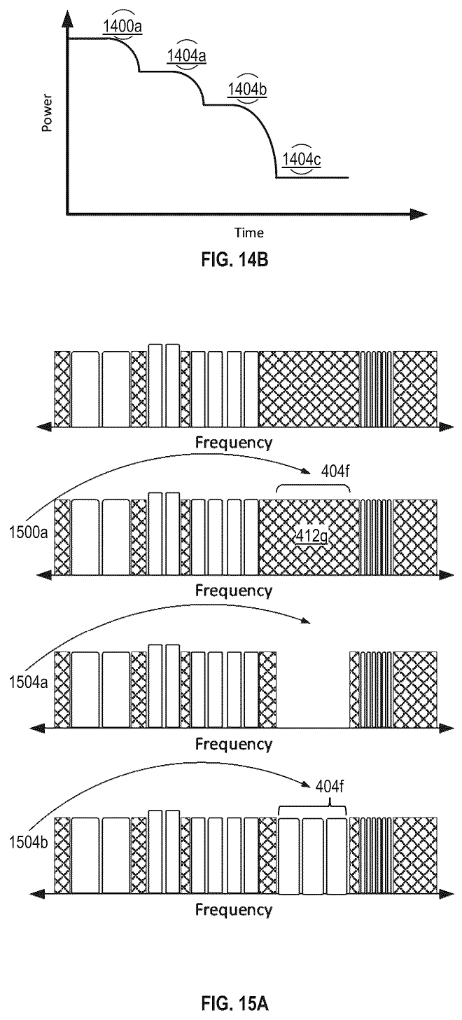

Referring now to FIG. 14A, shown therein is an exemplary implementation of a sequence of deactivating an optical service in the optical transport network 10 using the network element 14 utilizing sub-passband 600 ramping in accordance with the present disclosure. As shown in FIG. 14A, the user or the computer system 30 provisions the fifth SP 404e to deactivate the optical service (indicated by reference character 1400a), and the network element 14 divides the operation into a plurality of sub-operations, including deactivating one of a plurality of eighteenth sub-passbands 600s in the first loading cycle (indicated by reference character 1404a), performing the first AGC cycle (indicated by reference character 1408a) and/or adjusting one or more amplifier gain and/or tilt setpoints if necessary, deactivating another of the plurality of eighteenth sub-passbands 600s in a second loading cycle (indicated by reference character 1404b), performing a second AGC cycle (indicated by reference character 1408b) and/or adjusting one or more amplifier gain and/or tilt setpoints if necessary, deactivating the last of the plurality of eighteenth sub-passbands 600s in a third loading cycle (indicated by reference character 1404c), performing a third AGC cycle (indicated by reference character 1408c) and/or adjusting one or more amplifier gain and/or tilt setpoints if necessary, and completing deactivation of the optical service.

As shown in FIG. 14B, when the network element 14 utilizing sub-passband 600 ramping deactivates each of the plurality of eighteenth sub-passbands 600s in the first loading cycle (indicated by reference character 1404a), the second loading cycle (indicated by reference character 1404b), and the third loading cycle (indicated by reference character 1404c), the total optical power in the optical fiber link 22d-f decreases by the same amount, but because the network element is able to perform AGC cycles and adjust one or more amplifier gain and/or tilt setpoint between each loading cycle, if necessary, the total accumulated perturbation from deactivating the fifth SP 404e is minimized. As further shown in FIG. 14B, this results in the total optical power in the optical fiber link 22d-f decreasing only slightly in each step.

Utilizing sub-passband 600 ramping provides additional advantages in network elements 14 having an ASE idler (i.e., the ASE source 106) by allowing for smoother transitions between SPs 404 and APs 412 and reducing the total power excursion into the OMS during loading operations. Managing the total power excursion during a loading operation is essential to minimize transients due to the change in SRS dynamics and other loading-dependent optical effects within the OMS.

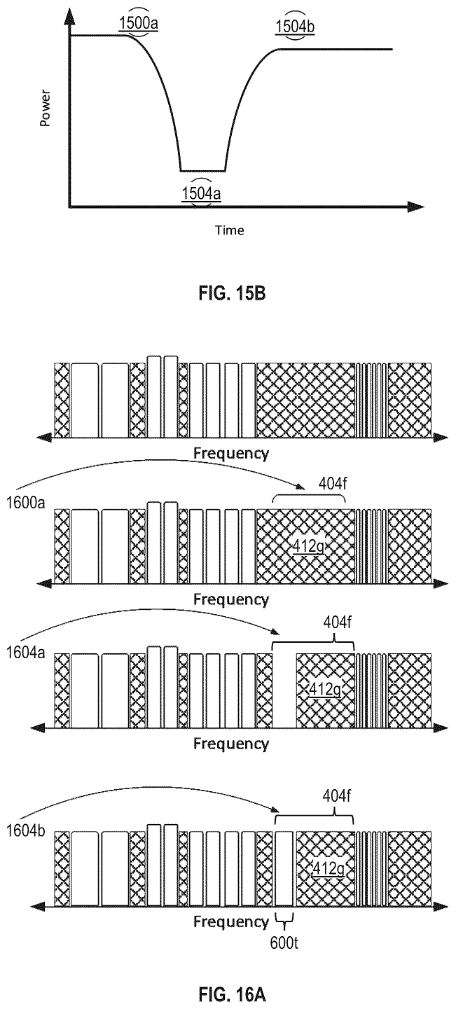

Referring now to FIG. 15A, shown therein is an exemplary implementation of a sequence of activating an optical service in the optical transport network 10 using the network element 14 with the ASE source 106 but not utilizing sub-passband 600 ramping in accordance with the present disclosure. As shown in FIG. 15A, a user or the computer system 30 provisions one or more sixth SPs 404f to activate an optical service (indicated by reference character 1500a), and the network element 14 performs the operation by deactivating and/or resizing one or more seventh APs 412g in a first loading cycle (indicated by reference character 1504a), activating the one or more sixth SPs 404f in a second loading cycle (indicated by reference character 1504b), and completing activation of the optical service.

As shown in FIG. 15B, when the network element 14 with the ASE source 106 but not utilizing sub-passband 600 ramping deactivates the one or more seventh APs 412g in the first loading cycle (indicated by reference character 1504a), the total optical power in the optical fiber link 22d-f decreases substantially, and when the network element 14 with the ASE source 106 but not utilizing sub-passband 600 ramping activates the one or more sixth SPs 404f in the second loading cycle (indicated by reference character 1504b), the total optical power in the optical fiber link 22d-f increases substantially.

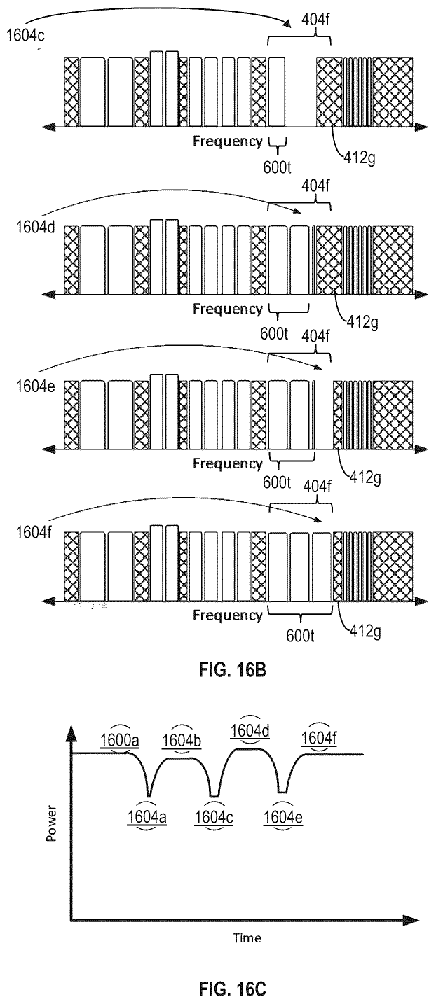

Referring now to FIGS. 16A and 16B, shown therein is an exemplary implementation of a sequence of activating an optical service in the optical transport network 10 using the network element 14 with the ASE source 106 and utilizing sub-passband 600 ramping in accordance with the present disclosure. As shown in FIGS. 16A and 16B, a user or the computer system 30 provisions one or more sixth SPs 404f to activate an optical service (indicated by reference character 1600a), and the network element 14 divides the operation into a plurality of sub-operations, including deactivating and/or resizing a first one of the one or more seventh APs 412g to accommodate a first one of a plurality of nineteenth sub-passbands 600t in a first loading cycle (indicated by reference character 1604a), activating the first one of the plurality of nineteenth sub-passbands 600t in a second loading cycle (indicated by reference character 1604b), deactivating and/or resizing a second one of the one or more seventh APs 412g to accommodate a second one of the plurality of nineteenth sub-passbands 600t in a third loading cycle (indicated by reference character 1604c), activating the second one of the plurality of nineteenth sub-passbands 600t in a fourth loading cycle (indicated by reference character 1604d), deactivating and/or resizing a third one of the one or more seventh APs 412g to accommodate a last one of the plurality of nineteenth sub-passbands 600t in a fifth loading cycle (indicated by reference character 1604e), activating a third one of the plurality of nineteenth sub-passbands 600t in a sixth loading cycle (indicated by reference character 1604f), and completing activation of the optical service.

As shown in FIG. 16C, when the network element 14 with the ASE source 106 and utilizing sub-passband 600 ramping deactivates each of the first one of the one or more seventh APs 412g in the first loading cycle (indicated by reference character 1604a), the second one of the one or more seventh APs 412g in the third loading cycle (indicated by reference character 1604c), and the third one of the one or more seventh APs 412g in the fifth loading cycle (indicated by reference character 1604e), the total optical power in the optical fiber link 22d-f decreases only slightly. Further, when the network element 14 with the ASE source 106 and utilizing sub-passband 600 ramping activates each of the first one of the one or more nineteenth sub-passbands 600t in the second loading cycle (indicated by reference character 1604b), the second one of the one or more nineteenth sub-passbands 600t in the fourth loading cycle (indicated by reference character 1604d), and the third one of the one or more nineteenth sub-passbands 600t in the sixth loading cycle (indicated by reference character 1604f), the total optical power in the optical fiber link 22d-f increases only slightly.

FIGS. 15B and 16C illustrate one benefit of utilizing sub-passband 600 ramping in network elements 14 having ASE idlers (i.e., the ASE source 106). That is, without utilizing sub-passband 600 ramping (shown in FIG. 15B), the total optical power excursion that occurs between the user or the computer system 30 provisioning the one or more sixth SPs 404f to activate the optical service and the network element 14 completing activation of the optical service is substantially larger. Conversely, while utilizing sub-passband 600 ramping (shown in FIG. 16C), the total optical power excursion that occurs between the user or the computer system 30 provisioning the one or more sixth SPs 404f to activate the optical service and the network element 14 completing activation of the optical service is substantially smaller. Thus, it is shown that, for systems (i.e., the network element 14) with ASE idlers (i.e., the ASE source 106), activating and/or deactivating services at the sub-passband level allows for a smoother transition between SPs and APs and minimizes the perturbation to the OMS.

It should be understood that the sequence for deactivating an optical service is the same as the sequence for activating an optical service as described above, but the steps are executed in the reverse order.

### Non-Limiting Illustrative Implementations

The following is a list of non-limiting illustrative implementations disclosed herein:

Illustrative implementation 1. A network element, comprising: a processor; and a non-transitory processor-readable medium storing processor-executable instructions that when executed by the processor cause the processor to: receive an operation to execute, the operation being one of an activation and a deactivation of one or more signal passbands (SPs) in an optical spectrum for transmission in a fiber optic line, each of the one or more SPs containing one or more optical carriers carrying user data; divide the operation into a plurality of sub-operations including a first sub-operation and a second sub-operation, the first sub-operation identifying one or more first sub-passbands, the second sub-operation identifying one or more second sub-passbands, each of the one or more first sub-passbands and the one or more second sub-passbands being a portion of the one or more SPs; execute the first sub-operation in a first loading cycle, thereby activating or deactivating the one or more first sub-passbands in the optical spectrum for transmission in the fiber optic line; and execute the second sub-operation in a second loading cycle after the first loading cycle, thereby activating or deactivating the one or more second sub-passbands in the optical spectrum for transmission in the fiber optic line.

Illustrative implementation 2. The network element of illustrative implementation 1, further comprising a wavelength-selective switch (WSS) having a minimum channel bandwidth, the one or more first sub-passbands identified by the first sub-operation having a first bandwidth, the one or more second sub-passbands identified by the second sub-operation having a second bandwidth, the first bandwidth and the second bandwidth being greater than or equal to the minimum channel bandwidth.

Illustrative implementation 3. The network element of illustrative implementation 2, wherein the first bandwidth of the one or more first sub-passbands is not equal to the second bandwidth of the one or more second sub-passbands.

Illustrative implementation 4. The network element of illustrative implementation 2, wherein the first bandwidth of the one or more first sub-passbands is equal to the second bandwidth of the one or more second sub-passbands.

Illustrative implementation 5. The network element of illustrative implementation 2, wherein the minimum channel bandwidth of the WSS is one of 3.125 Gigahertz (GHz), 6.25 GHz, 10 GHz, 12.5 GHz, 25 GHz, 50 GHz, and 100 GHz.

Illustrative implementation 6. The network element of illustrative implementation 2, wherein the WSS has a predetermined frequency grid, the one or more first sub-passbands having one or more first sub-passbands start frequency and one or more first sub-passbands end frequency, the one or more second sub-passbands having one or more second sub-passbands start frequency and one or more second sub-passbands end frequency, the one or more first sub-passbands start frequency, the one or more first sub-passbands end frequency, the one or more second sub-passbands start frequency, and the one or more second sub-passbands end frequency being aligned with the predetermined frequency grid.

Illustrative implementation 7. The network element of illustrative implementation 6, wherein the predetermined frequency grid conforms to a Dense Wavelength Division Multiplexing (DWDM) frequency grid defined by Recommendation G.694.1, Edition 3.0, approved by the International Telecommunication Union (ITU) Telecommunication Standardization Sector (ITU-T) on Oct. 29, 2020.

Illustrative implementation 8. The network element of illustrative implementation 6, wherein the predetermined frequency grid of the WSS has an anchor frequency and a plurality of central frequencies, each of the plurality of central frequencies being determined based on the formula a+m×n, a being the anchor frequency, m being the minimum channel bandwidth of the WSS, n being an integer.

Illustrative implementation 9. The network element of illustrative implementation 8, wherein the anchor frequency is 193.1 THz.

Illustrative implementation 10. A network element, comprising: an amplified spontaneous emission (ASE) source configured to generate ASE noise; a processor; and a non-transitory processor-readable medium storing processor-executable instructions that when executed by the processor cause the processor to: activate an ASE passband (AP) in an unoccupied band of an optical spectrum for transmission in a fiber optic line, the AP having an ASE start frequency and an ASE end frequency and being loaded with the ASE noise; receive an operation to execute, the operation being an activation of one or more signal passbands (SPs) in the optical spectrum for transmission in the fiber optic line, the one or more SPs having a SP start frequency greater than or equal to the ASE start frequency and a SP end frequency less than or equal to the ASE end frequency, each of the one or more SPs containing one or more optical carriers carrying user data; divide the operation into a plurality of sub-operations including a first sub-operation and a second sub-operation, the first sub-operation identifying one or more first sub-passbands and the second sub-operation identifying one or more second sub-passbands, each of the one or more first sub-passbands and the one or more second sub-passbands being a portion of the one or more SPs; deactivate a first portion of the AP in the optical spectrum for transmission in the fiber optic line, the first portion overlapping with the one or more first sub-passbands;
execute the first sub-operation in a first loading cycle, thereby activating the one or more first sub-passbands in the optical spectrum for transmission in the fiber optic line; deactivate a second portion of the AP in the optical spectrum for transmission in the fiber optic line, the second portion overlapping with the one or more second sub-passbands; and execute the second sub-operation in a second loading cycle after the first loading cycle, thereby activating the one or more second sub-passbands in the optical spectrum for transmission in the fiber optic line.

Illustrative implementation 11. The network element of illustrative implementation 10, wherein deactivating the first portion of the AP is further defined as deactivating the first portion of the AP in the optical spectrum for transmission in the fiber optic line in the first loading cycle prior to executing the first sub-operation.

Illustrative implementation 12. The network element of illustrative implementation 11, wherein deactivating the second portion of the AP is further defined as deactivating the second portion of the AP in the optical spectrum for transmission in the fiber optic line in the second loading cycle prior to executing the second sub-operation.

Illustrative implementation 13. The network element of illustrative implementation 10, wherein deactivating the first portion of the AP is further defined as deactivating the first portion of the AP in the optical spectrum for transmission in the fiber optic line in a third loading cycle before the first loading cycle.

Illustrative implementation 14. The network element of illustrative implementation 13, wherein deactivating the second portion of the AP is further defined as deactivating the second portion of the AP in the optical spectrum for transmission in the fiber optic line in a fourth loading cycle prior between the first loading cycle and the second loading cycle.

Illustrative implementation 15. The network element of illustrative implementation 10, further comprising a wavelength-selective switch (WSS) having a minimum channel bandwidth, the one or more first sub-passbands identified by the first sub-operation having a first bandwidth, the one or more second sub-passbands identified by the second sub-operation having a second bandwidth, the first bandwidth and the second bandwidth being greater than or equal to the minimum channel bandwidth.

Illustrative implementation 16. The network element of illustrative implementation 15, wherein the first bandwidth of the one or more first sub-passbands is not equal to the second bandwidth of the one or more second sub-passbands.

Illustrative implementation 17. The network element of illustrative implementation 15, wherein the first bandwidth of the one or more first sub-passbands is equal to the second bandwidth of the one or more second sub-passbands.

Illustrative implementation 18. The network element of illustrative implementation 15, wherein the minimum channel bandwidth of the WSS is one of 3.125 Gigahertz (GHz), 6.25 GHz, 10 GHz, 12.5 GHz, 25 GHz, 50 GHz, and 100 GHz.

Illustrative implementation 19. The network element of illustrative implementation 15, wherein the WSS has a predetermined frequency grid, the one or more first sub-passbands having one or more first sub-passbands start frequency and one or more first sub-passbands end frequency, the one or more second sub-passbands having one or more second sub-passbands start frequency and one or more second sub-passbands end frequency, the one or more first sub-passbands start frequency, the one or more first sub-passbands end frequency, the one or more second sub-passbands start frequency, and the one or more second sub-passbands end frequency being aligned with the predetermined frequency grid.

Illustrative implementation 20. The network element of illustrative implementation 19, wherein the predetermined frequency grid conforms to a Dense Wavelength Division Multiplexing (DWDM) frequency grid defined by Recommendation G.694.1, Edition 3.0, approved by the International Telecommunication Union (ITU) Telecommunication Standardization Sector (ITU-T) on Oct. 29, 2020.

Illustrative implementation 21. The network element of illustrative implementation 19, wherein the predetermined frequency grid of the WSS has an anchor frequency and a plurality of central frequencies, each of the plurality of central frequencies being determined based on the formula a+m×n, a being the anchor frequency, m being the minimum channel bandwidth of the WSS, n being an integer.

Illustrative implementation 22. The network element of illustrative implementation 21, wherein the anchor frequency is 193.1 THz.

Illustrative implementation 23. A network element, comprising: an amplified spontaneous emission (ASE) source configured to generate ASE noise; a processor; and a non-transitory processor-readable medium storing processor-executable instructions that when executed by the processor cause the processor to: activate one or more signal passbands (SPs) in an optical spectrum for transmission in a fiber optic line, each of the one or more SPs containing one or more optical carriers carrying user data; receive an operation to execute, the operation being a deactivation of at least one of the one or more SPs in the optical spectrum for transmission in the fiber optic line; divide the operation into a plurality of sub-operations including a first sub-operation and a second sub-operation, the first sub-operation identifying one or more first sub-passbands and the second sub-operation identifying one or more second sub-passbands, each of the one or more first sub-passbands and the one or more second sub-passbands being a portion of the at least one of the one or more SPs; execute the first sub-operation in a first loading cycle, thereby deactivating the one or more first sub-passbands in the optical spectrum for transmission in the fiber optic line; activate a first ASE passband (AP) in a first unoccupied band of the optical spectrum for transmission in the fiber optic line previously occupied by the one or more first sub-passbands, the first AP being loaded with the ASE noise;
execute the second sub-operation in a second loading cycle after the first loading cycle, thereby deactivating the one or more second sub-passbands in the optical spectrum for transmission in the fiber optic line; and activate a second AP in a second unoccupied band of the optical spectrum for transmission in the fiber optic line previously occupied by the one or more second sub-passbands, the second AP being loaded with the ASE noise.

Illustrative implementation 24. The network element of illustrative implementation 23, wherein activating the first AP is further defined as activating the first AP in the first unoccupied band of the optical spectrum for transmission in the fiber optic line previously occupied by the one or more first sub-passbands in the first loading cycle subsequent to executing the first sub-operation.

Illustrative implementation 25. The network element of illustrative implementation 24, wherein activating the second AP is further defined as activating second first AP in the second unoccupied band of the optical spectrum for transmission in the fiber optic line previously occupied by the one or more second sub-passbands in the second loading cycle subsequent to executing the second sub-operation.

Illustrative implementation 26. The network element of illustrative implementation 23, wherein activating the first AP is further defined as activating the first AP in the first unoccupied band of the optical spectrum for transmission in the fiber optic line previously occupied by the one or more first sub-passbands in a third loading cycle between the first loading cycle and the second loading cycle.

Illustrative implementation 27. The network element of illustrative implementation 26, wherein activating the second AP is further defined as activating second first AP in the second unoccupied band of the optical spectrum for transmission in the fiber optic line previously occupied by the one or more second sub-passbands in a fourth loading cycle prior between after the second loading cycle.

Illustrative implementation 28. The network element of illustrative implementation 23, further comprising a wavelength-selective switch (WSS) having a minimum channel bandwidth, the one or more first sub-passbands identified by the first sub-operation having a first bandwidth and the one or more second sub-passbands identified by the second sub-operation having a second bandwidth, the first bandwidth and the second bandwidth being greater than or equal to the minimum channel bandwidth.

Illustrative implementation 29. The network element of illustrative implementation 28, wherein the first bandwidth of the one or more first sub-passbands is not equal to the second bandwidth of the one or more second sub-passbands.

Illustrative implementation 30. The network element of illustrative implementation 28, wherein the first bandwidth of the one or more first sub-passbands is equal to the second bandwidth of the one or more second sub-passbands.

Illustrative implementation 31. The network element of illustrative implementation 28, wherein the minimum channel bandwidth of the WSS is one of 3.125 Gigahertz (GHz), 6.25 GHz, 10 GHz, 12.5 GHz, 25 GHz, 50 GHz, and 100 GHz.

Illustrative implementation 32. The network element of illustrative implementation 28, wherein the WSS has a predetermined frequency grid, the one or more first sub-passbands having one or more first sub-passbands start frequency and one or more first sub-passbands end frequency, the one or more second sub-passbands having one or more second sub-passbands start frequency and one or more second sub-passbands end frequency, the one or more first sub-passbands start frequency, the one or more first sub-passbands end frequency, the one or more second sub-passbands start frequency, and the one or more second sub-passbands end frequency being aligned with the predetermined frequency grid.

Illustrative implementation 33. The network element of illustrative implementation 32, wherein the predetermined frequency grid conforms to a Dense Wavelength Division Multiplexing (DWDM) frequency grid defined by Recommendation G.694.1, Edition 3.0, approved by the International Telecommunication Union (ITU) Telecommunication Standardization Sector (ITU-T) on Oct. 29, 2020.

Illustrative implementation 34. The network element of illustrative implementation 32, wherein the predetermined frequency grid of the WSS has an anchor frequency and a plurality of central frequencies, each of the plurality of central frequencies being determined based on the formula a+m×n, a being the anchor frequency, m being the minimum channel bandwidth of the WSS, n being an integer.

Illustrative implementation 35. The network element of illustrative implementation 34, wherein the anchor frequency is 193.1 THz.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

What is claimed is:

1. A network element, comprising:
a processor; and
a non-transitory processor-readable medium storing processor-executable instructions that when executed by the processor cause the processor to:
receive an operation to execute, the operation being one of an activation and a deactivation of one or more signal passbands (SPs) in an optical spectrum for transmission in a fiber optic line, each of the one or more SPs containing one or more optical carriers carrying user data;
divide the operation into a plurality of sub-operations including a first sub-operation and a second sub-operation, the first sub-operation identifying one or more first sub-passbands, the second sub-operation identifying one or more second sub-passbands, each of the one or more first sub-passbands and the one or more second sub-passbands being a portion of the one or more SPs;
execute the first sub-operation in a first loading cycle, thereby activating or deactivating the one or more first sub-passbands in the optical spectrum for transmission in the fiber optic line; and
execute the second sub-operation in a second loading cycle after the first loading cycle, thereby activating or deactivating the one or more second sub-passbands in the optical spectrum for transmission in the fiber optic line.

2. The network element of claim 1, further comprising a wavelength-selective switch (WSS) having a minimum channel bandwidth, the one or more first sub-passbands identified by the first sub-operation having a first bandwidth, the one or more second sub-passbands identified by the second sub-operation having a second bandwidth, the first bandwidth and the second bandwidth being greater than or equal to the minimum channel bandwidth.

3. The network element of claim 2, wherein the first bandwidth of the one or more first sub-passbands is not equal to the second bandwidth of the one or more second sub-passbands.

4. The network element of claim 2, wherein the first bandwidth of the one or more first sub-passbands is equal to the second bandwidth of the one or more second sub-passbands.

5. The network element of claim 2, wherein the minimum channel bandwidth of the WSS is one of 3.125 Gigahertz (GHz), 6.25 GHz, 10 GHz, 12.5 GHz, 25 GHz, 50 GHz, and 100 GHz.

6. The network element of claim 2, wherein the WSS has a predetermined frequency grid, the one or more first sub-passbands having one or more first sub-passbands start frequency and one or more first sub-passbands end frequency, the one or more second sub-passbands having one or more second sub-passbands start frequency and one or more second sub-passbands end frequency, the one or more first sub-passbands start frequency, the one or more first sub-passbands end frequency, the one or more second sub-passbands start frequency, and the one or more second sub-passbands end frequency being aligned with the predetermined frequency grid.

7. The network element of claim 6, wherein the predetermined frequency grid conforms to a Dense Wavelength Division Multiplexing (DWDM) frequency grid defined by Recommendation G.694.1, Edition 3.0, approved by the International Telecommunication Union (ITU) Telecommunication Standardization Sector (ITU-T) on Oct. 29, 2020.

8. The network element of claim 6, wherein the predetermined frequency grid of the WSS has an anchor frequency and a plurality of central frequencies, each of the plurality of central frequencies being determined based on the formula a+m×n, a being the anchor frequency, m being the minimum channel bandwidth of the WSS, n being an integer.

9. The network element of claim 8, wherein the anchor frequency is 193.1 THz.

10. A network element, comprising:
an amplified spontaneous emission (ASE) source configured to generate ASE noise;
a processor; and
a non-transitory processor-readable medium storing processor-executable instructions that when executed by the processor cause the processor to:
activate an ASE passband (AP) in an unoccupied band of an optical spectrum for transmission in a fiber optic line, the AP having an ASE start frequency and an ASE end frequency and being loaded with the ASE noise;
receive an operation to execute, the operation being an activation of one or more signal passbands (SPs) in the optical spectrum for transmission in the fiber optic line, the one or more SPs having a SP start frequency greater than or equal to the ASE start frequency and a SP end frequency less than or equal to the ASE end frequency, each of the one or more SPs containing one or more optical carriers carrying user data;
divide the operation into a plurality of sub-operations including a first sub-operation and a second sub-operation, the first sub-operation identifying one or more first sub-passbands and the second sub-operation identifying one or more second sub-passbands, each of the one or more first sub-passbands and the one or more second sub-passbands being a portion of the one or more SPs;
deactivate a first portion of the AP in the optical spectrum for transmission in the fiber optic line, the first portion overlapping with the one or more first sub-passbands;
execute the first sub-operation in a first loading cycle, thereby activating the one or more first sub-passbands in the optical spectrum for transmission in the fiber optic line;
deactivate a second portion of the AP in the optical spectrum for transmission in the fiber optic line, the second portion overlapping with the one or more second sub-passbands; and
execute the second sub-operation in a second loading cycle after the first loading cycle, thereby activating the one or more second sub-passbands in the optical spectrum for transmission in the fiber optic line.

11. The network element of claim 10, wherein deactivating the first portion of the AP is further defined as deactivating the first portion of the AP in the optical spectrum for transmission in the fiber optic line in the first loading cycle prior to executing the first sub-operation.

12. The network element of claim 11, wherein deactivating the second portion of the AP is further defined as deactivating the second portion of the AP in the optical spectrum for transmission in the fiber optic line in the second loading cycle prior to executing the second sub-operation.

13. The network element of claim 10, wherein deactivating the first portion of the AP is further defined as deactivating the first portion of the AP in the optical spectrum for transmission in the fiber optic line in a third loading cycle before the first loading cycle.

14. The network element of claim 13, wherein deactivating the second portion of the AP is further defined as deactivating the second portion of the AP in the optical spectrum for transmission in the fiber optic line in a fourth loading cycle prior between the first loading cycle and the second loading cycle.

15. The network element of claim 10, further comprising a wavelength-selective switch (WSS) having a minimum channel bandwidth, the one or more first sub-passbands identified by the first sub-operation having a first bandwidth, the one or more second sub-passbands identified by the second sub-operation having a second bandwidth, the first bandwidth and the second bandwidth being greater than or equal to the minimum channel bandwidth, wherein the minimum channel bandwidth of the WSS is one of 3.125 Gigahertz (GHz), 6.25 GHz, 10 GHz, 12.5 GHz, 25 GHz, 50 GHz, and 100 GHz.

16. The network element of claim 15, wherein the WSS has a predetermined frequency grid, the one or more first sub-passbands having one or more first sub-passbands start frequency and one or more first sub-passbands end frequency, the one or more second sub-passbands having one or more second sub-passbands start frequency and one or more second sub-passbands end frequency, the one or more first sub-passbands start frequency, the one or more first sub-passbands end frequency, the one or more second sub-passbands start frequency, and the one or more second sub-passbands end frequency being aligned with the predetermined frequency grid.

17. The network element of claim 16, wherein the predetermined frequency grid conforms to a Dense Wavelength Division Multiplexing (DWDM) frequency grid defined by Recommendation G.694.1, Edition 3.0, approved by the International Telecommunication Union (ITU) Telecommunication Standardization Sector (ITU-T) on Oct. 29, 2020.

18. The network element of claim 17, wherein the predetermined frequency grid of the WSS has an anchor frequency and a plurality of central frequencies, each of the plurality of central frequencies being determined based on the formula a+m×n, a being the anchor frequency, m being the minimum channel bandwidth of the WSS, n being an integer.

19. The network element of claim 18, wherein the anchor frequency is 193.1 THz.

20. A network element, comprising:
an amplified spontaneous emission (ASE) source configured to generate ASE noise;
a processor; and
a non-transitory processor-readable medium storing processor-executable instructions that when executed by the processor cause the processor to:
activate one or more signal passbands (SPs) in an optical spectrum for transmission in a fiber optic line, each of the one or more SPs containing one or more optical carriers carrying user data;
receive an operation to execute, the operation being a deactivation of at least one of the one or more SPs in the optical spectrum for transmission in the fiber optic line;
divide the operation into a plurality of sub-operations including a first sub-operation and a second sub-operation, the first sub-operation identifying one or more first sub-passbands and the second sub-operation identifying one or more second sub-passbands, each of the one or more first sub-passbands and the one or more second sub-passbands being a portion of the at least one of the one or more SPs;
execute the first sub-operation in a first loading cycle, thereby deactivating the one or more first sub-passbands in the optical spectrum for transmission in the fiber optic line;
activate a first ASE passband (AP) in a first unoccupied band of the optical spectrum for transmission in the fiber optic line previously occupied by the one or more first sub-passbands, the first AP being loaded with the ASE noise;
execute the second sub-operation in a second loading cycle after the first loading cycle, thereby deactivating the one or more second sub-passbands in the optical spectrum for transmission in the fiber optic line; and
activate a second AP in a second unoccupied band of the optical spectrum for transmission in the fiber optic line previously occupied by the one or more second sub-passbands, the second AP being loaded with the ASE noise.
